(19) United States
(12) Patent Application Publication
(10) Pub. No.: US 2019/0182155 A1
(43) Pub. Date: Jun. 13, 2019

(54) Distributed Network Sharing And Traffic Isolation

(71) Applicant: Mingtai Chang, Harvard, MA (US)

(72) Inventor: Mingtai Chang, Harvard, MA (US)

(21) Appl. No.: 16/212,330

(22) Filed: Dec. 6, 2018

Related U.S. Application Data
(60) Provisional application No. 62/596,017, filed on Dec. 7, 2017.

(51) Int. Cl. H04L 12/741; H04L 29/08; H04L 29/06; H04L 29/12

(52) U.S. Cl. CPC H04L 45/74; H04L 67/10; H04L 12/4641; H04L 61/251; H04L 61/6059; H04L 69/22

(57) ABSTRACT

Systems, methods, devices, and other techniques for supporting multiple host systems isolated from each other in their individual address plans but sharing a common core of network routers and resources.

### CLAIM OF PRIORITY

This application claims priority to U.S. Provisional Application Ser. No. 62/596,017, filed on Dec. 7, 2017, the entire contents of which are hereby incorporated by reference.

### BACKGROUND

A host system refers to of one or more computer systems or devices linked via a local area network (LAN), a wide area network (WAN), a virtual private network (VPN) or a combination of these networks. In a corporate environment, the host system is typically distributed as a set of branches or sites, typically including the head office and various geographically dispersed regional offices, each of which contains a set of computers or devices accessible via one or many branch gateways resident in the branch or site. A virtual private network (VP N) extends a host system across a public or shared network and enables users to send and receive data across the shared network as if their computing devices were directly and exclusively connected to each other in the same host system through private routers based on a consistent IP address plan. Within the host system, a device is typically assigned one or more unicast addresses for identification and routing purposes, which do not duplicate those of any other devices within the same host system if they are to be globally identifiable within the same host system. In the environment where many different host systems share a common network or routing infrastructure like the Internet, a host system may further distribute its hosts or devices as mobile units, which move around on the shared network and attempt to connect to their private host system through the shared infrastructure. This is known as remote access by remote clients in the context of VPN. In the remote access scenario, the assignment of unicast addresses to those remote clients can be dynamically established when the remote connection is attempted.

A consistent address assignment and route aggregation scheme which makes some selected set of devices within a host system individually identifiable and reachable from other parts of the same host system is termed an address plan. A VPN is considered as an intranet that serves a specific type of users within a particular host system (such as employees of a corporation, or students at a school). For this purpose, the VPN usually operates under a consistent address plan, which is self-contained and not accessible to the general public or other host systems but may allow remote access by authorized personnel located outside its branch sites.

Ideally, all private host systems may determine their own unique address plan allowing exclusive reachability and connectivity among their private hosts or devices. However, if the shared network like the Internet is to be used for wide area connectivity, the reachability of members for a particular host system depends on the routes and hence those ISPs hired which dictate the address assignment to parts of the host system and influence that to the rest of the system. This difficulty for a host system connected to the Internet to independently determine its own address plan is partially due to the lack of a universal naming standard for individual hosts and the fact that a host or device is identified by the addresses assigned to their network interfaces. Furthermore, even if a universal all-encompassing naming plan could have been offered independently from the address plans, the privacy and security of accesses to individual host systems must still be provided. It is believed that universal reachability of individual hosts or devices in any host systems, even if achievable, would make the security issues substantially more difficult. The generally accepted approach to maintain both the security and addressability for a host system connected to a shared network cloud is the VPN approach. It assumes individual VPNs are self-contained, autonomous, private, and protected from each other through some access insulation mechanism. MPLS has been quite successful in providing such a reachability and security infrastructure based on an isolation scheme for segregating individual host systems from each other.

Some individual enterprises deploy IP VPN (Internet Protocol based Virtual Private Network) technology to demarcate their own private devices from other enterprises. Those VPNs are usually implemented and deployed independently by individual enterprises, using the Internet as a conduit for delivering intra-enterprise traffic through some IP tunneling technology. Each IP VPN is self-contained, with its own chosen address plan and routing schemes without regard to other host systems. Since they confine their network access mainly within the same VPN, there may be overlapping addresses among different VPNs without risking interference with each other. As the IP VPN technology is IP based, it is straightforward for the client to make remote access to any one of the branches by connecting to their gateways. However, since IP VPNs are individually implemented and managed involving diversified technologies in network routing and tunneling in order to take advantage of the public Internet, it may lead to labor-intensive maintenance and is difficult or costly to outsource.

MPLS is another type of data-carrying technology based on which enterprises may build their individual VPNs by sharing an MPLS provider core. All VPNs are normally separated from each other, much like IP VPN, but running over the same WAN infrastructure or MPLS cloud for inter-branch connectivity. A representative MPLS service is diagramed in FIG. 1, where CE (Customer Edge router) is the customer premise gateway or routing equipment, PE (Provider Edge router) is the corresponding routing equipment situated on the edge of the MPLS cloud and P (Provider core router) is the router for directing traffic internally as the backbone of the MPLS cloud.

As those participating MPLS VPNs share the same routing infrastructure, they are centrally administrated over shared network resources. Routine maintenance is typically outsourced to the MPLS provider under a managed service contract. An MPLS VPN branch is typically substantial in size in order to justify the expenses of the CE. There is limited provision for mobile clients making individual accesses to a particular VPN from outside the MPLS cloud since to achieve the mobile access by a mobile client the CE function would have to be implemented in software and hosted on individual remote clients. Furthermore, even if the remote access client was able to perform the CE function, there would still be configuration issues in dynamically assigning the client to a particular PE.

As MPLS directs data from one network node to the next based on short path “labels” rather than long network addresses, the MPLS cloud uses its own servers to carry the MPLS traffic and is physically separate from the Internet.

### SUMMARY

The subject matter of this specification relates, in part, to systems, methods, devices, and other techniques for supporting multiple host systems isolated from each other in their individual address plans but sharing a common core of network routers and resources. Some implementations are fully compatible with the Internet Protocol suite without the need for a separate network infrastructure like MPLS different from the public Internet. It also supports remote client access to individual host systems or VPNs participating in sharing the shared infrastructure and intercommunication between VPNs in extranet settings, with the access to the public Internet as a special application of the inbuilt Extranet support.

Some implementations involve a data-carrying technique by which multiple VPNs may coexist over a single shared network infrastructure. The shared network infrastructure is sometimes referred to herein as the network cloud, network core, routing cloud, routing fabric, routing core, or simply core. In contrast to MPLS where the sharing of the underlying routing infrastructure by each individual VPN is not based on “labels”, the routing infrastructure may instead use a combination of address plan embedding, from individual base address plans into a larger “hyper address plan”, and a dynamic routing scheme based on the addresses in the larger hyper address plan. When deployed over the Internet, the routing core is still IP based and therefore can be constructed out of the standard IP routers completely consistent with current Internet infrastructure.

### DESCRIPTION OF THE DRAWINGS

FIG. 1 is a schematic diagram showing an example topology of the MPLS technology supporting multiple VPNs and sites.

FIG. 2A is a graphical representation of a network overlay.

FIG. 2B is a block diagram showing the software architecture of Spines, an open-source overlay messaging framework.

FIG. 2C is a schematic diagram showing a typical structure of a virtual TUN or TAP device, a software instrumentation for a virtual network interface or network adapter.

FIG. 2D is a graphical representation of how one or multiple virtual adapters are interconnected with each other.

FIG. 3 is the graphical representation of how typically a multitude of geographically distributed devices or hosts shares a common network core through gateways.

FIG. 4 is the graphical representation of how multiple VPNs are to share a common network core with inbuilt traffic isolation.

FIG. 5 is the graphical representation of a geographically dispersed deployment of a “logical” branch.

FIG. 6A is the layout of network packets in the Internet protocol suite as a layered architecture.

FIG. 6B is the graphical representation of an example mapping scheme from an IPv4 base address into its IPv6 hyper address counterpart.

FIG. 6C is the graphical representation of a specially designed VPN ID header containing the source VPN ID and destination VPN ID when the size of the IPv6 packet header becomes an issue.

FIG. 7A is the graphical representation of how a branch gateway connects to one or many relays in the network core.

FIG. 7B is the flow diagram showing the steps involved in carrying out the gateway registration process and entering the operating state after the successful registration.

FIG. 7C is the flow diagram showing the steps involved at the registration service running on the elected relay after receiving the registration request as depicted in FIG. 7B.

FIG. 7D is the flow diagram showing the steps carried out at the event on receiving a packet from the routing core and the steps at the event on receiving a packet from one of the registered gateways.

FIG. 7E is the flow diagram showing the steps involved in carrying out the remote access registration process at the remote client and entering the operating state after the successful registration.

FIG. 7F is the flow diagram showing the steps involved at the registration service running on the elected relay after receiving the registration request as depicted in FIG. 7E.

FIG. 7G is the flow diagram showing the steps involved in responding to the second phase of the remote access registration process at the remote client intended primarily for acquiring the virtual remote access address.

FIG. 8A is the graphical representation of the 3-section tunnels created to support the gateway to gateway connectivity and remote access client to gateway connectivity.

FIG. 8B is an packet flow representation which further details the gateway to gateway tunnel described as 810, 830 and 812 in FIG. 8A. It displays an example packet flow in terms of their packet header and tunnel encapsulation in the time sequence (vertical) and the space sequence from the source to the destination.

FIG. 8C is a similar representation as FIG. 8B, utilizing the database-assisted routing approach.

FIG. 8D is a similar representation as FIG. 8B for the remote access application scenario.

FIG. 9 is the graphical representation of connectivity when multiple VPNs are involved in sharing a common branch.

### DETAILED DESCRIPTION

Architectural Overview

The subject matter of this specification (including the claims and drawings) generally relates to environments having multiple host systems that share a network core, including VPN packet routing methods on the internet layer of the Internet Protocol suite deployed throughout the network core and all the host systems. For example, the technology provides systems, methods, devices, and other techniques that permit multiple host systems to share a common network core by connecting their branches to the shared core which routes packets among branches within their respective VPNs, subject to routing policies, such as QoS (quality of service) requirements or admission control which are originally defined for individual participating VPNs but extended to and supported by the shared core. Advantageously, these techniques can build in the isolation of traffic flows between different host systems. When properly configured and deployed, each host system may operate independently from all other host systems without concerns about traffic interference or content privacy.

The present technology focuses on the internet layer of the Internet Protocol suite, which provides the means of transferring variable-length data packets from a source host to its destination across network boundaries. The internet layer is a subset of the network layer within the service layering semantics of the OSI network architecture, which mainly responds to service requests from the transport layer and issues service requests to the data link layer. When the routing logic is described in this specification, the unit of transport is the packet, which is the basic component for forming the message that applications deal with on the transport layer.

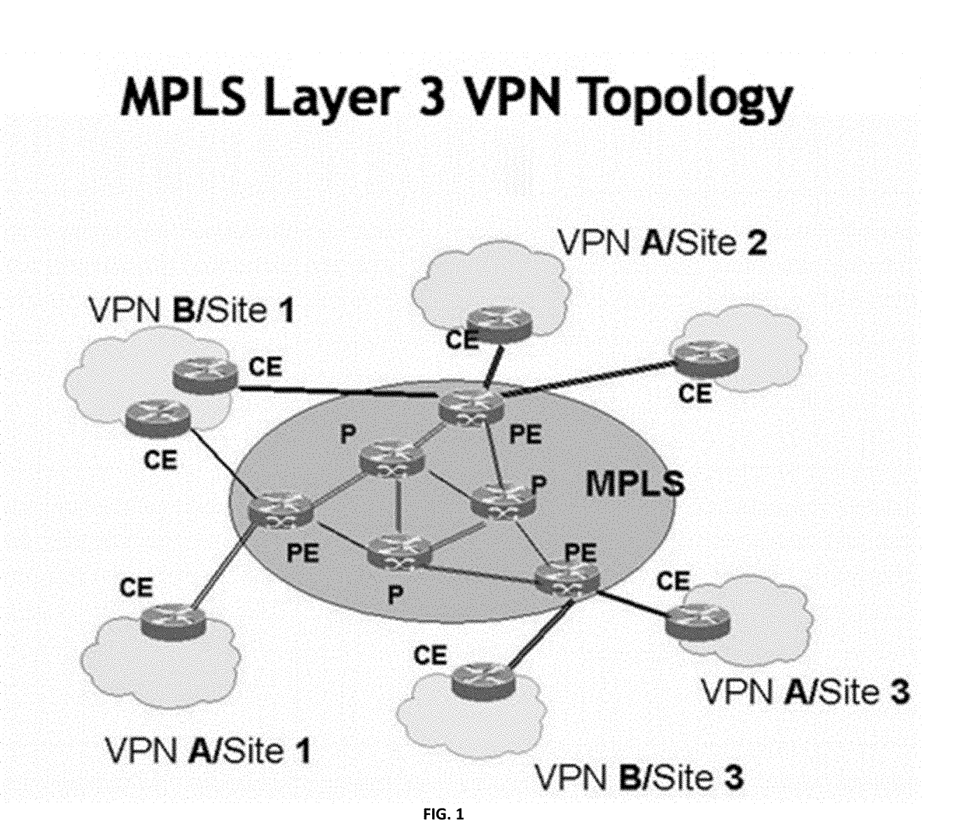

Each branch of a host system typically has at least one gateway, which is a router at the entry/exit of the branch for directing ingress/egress traffic to/from all the networks within the branch, and for conducting protocol conversion when necessary. The term gateway is not meant to be limited to a single type of devices. Any device, hardware or software, that may act as a router between the applications and the shared network core may be considered a gateway for purposes of this technology. An incoming packet must find its way to one of the branch gateways before getting delivered to the branch. Conversely, an outgoing packet must go through the gateways of its branch before getting routed through the core to its destination branch. In the MPLS context, the CE is the gateway of its resident branch, as depicted in FIG. 1. In the present technology there may be multiple gateways installed at a branch, which collectively forms a multi-homed configuration that allows multiple paths or routes leading to/from the branch.

The shared network core consists of a collection of servers called access relays or simply relays.

The traditional IP VPN technology is a well understood and accepted technology. It extends the connectivity of a private collection of branches or sites through IP tunnels implemented among the branch gateways over the public Internet and protected by encryption techniques such as IPsec or SSL/TLS when required. The private branches or sites are connected to each other through tunnels from the edges of the public Internet. Those branches or sites are typically mutually addressable with each other when required, or at least some of the branches or sites owning some public IP addresses through which all the sites are directly or indirectly reachable. FIG. 3 is one such perspective with user or application devices and hosts interfacing with the network core owned and operated mostly by carriers and ISPs in various Autonomous Systems partitions. As depicted, with the edge gateways 302 as routers supporting various VPNs, each gateway is responsible for routing packets from/to hosts in a subset of some specific branch or site. Those gateways 302 are each connecting to one or multiple designated core servers of the infrastructure. As network routers, those gateways functionally form a network mesh connecting branches with each other through end to end tunnels. However, for performance or QoS considerations, some of the virtual links in the mesh are trimmed off from the core to optimize the routing logic and the calculation cost of best routes.

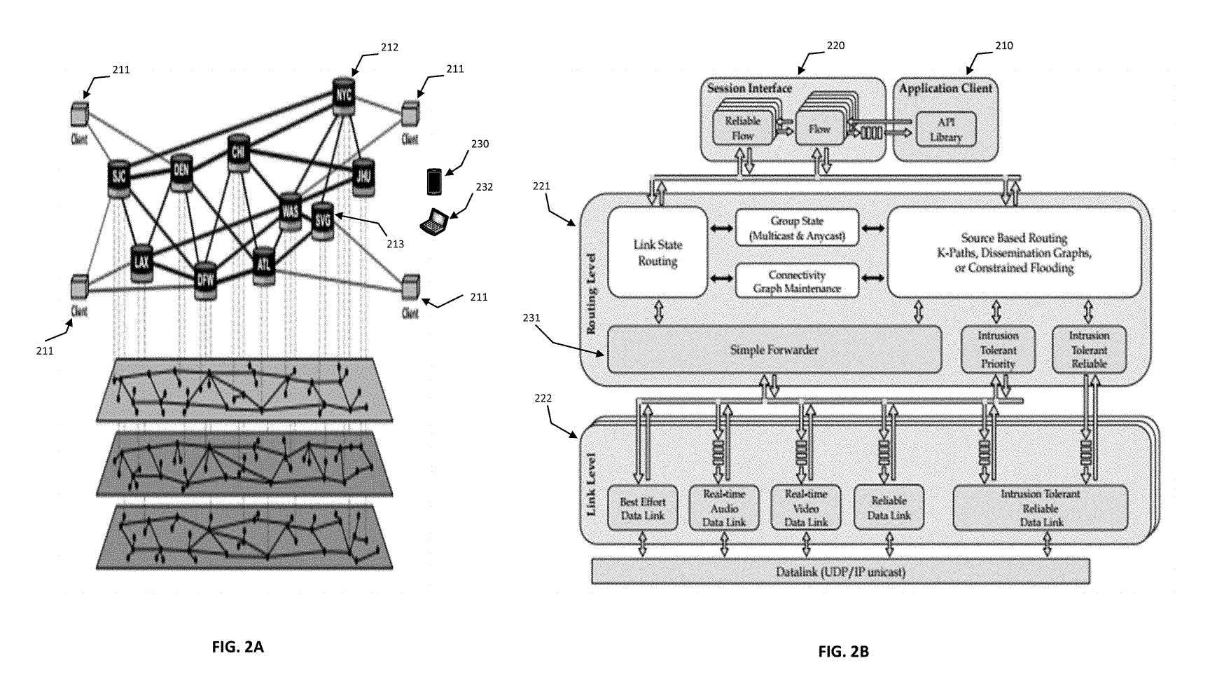

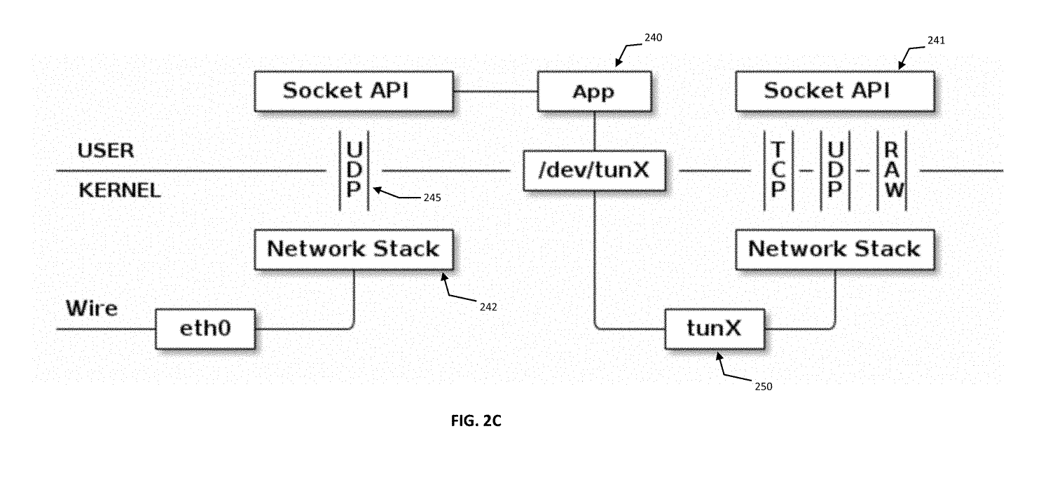

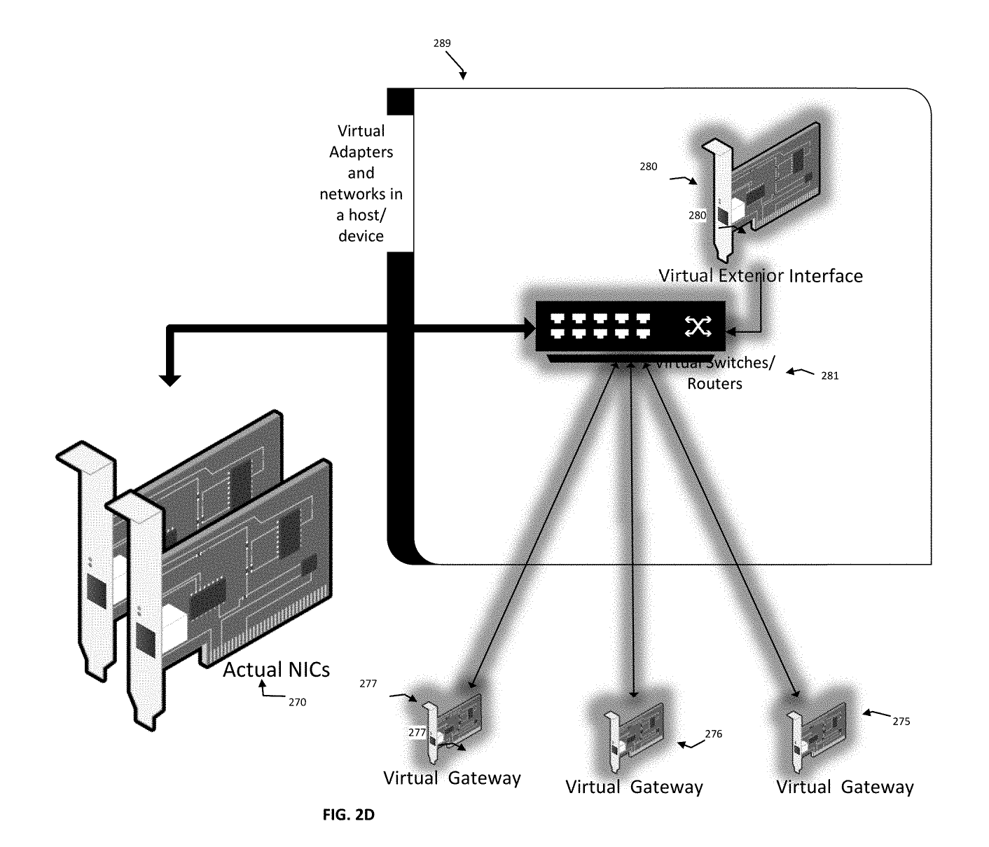

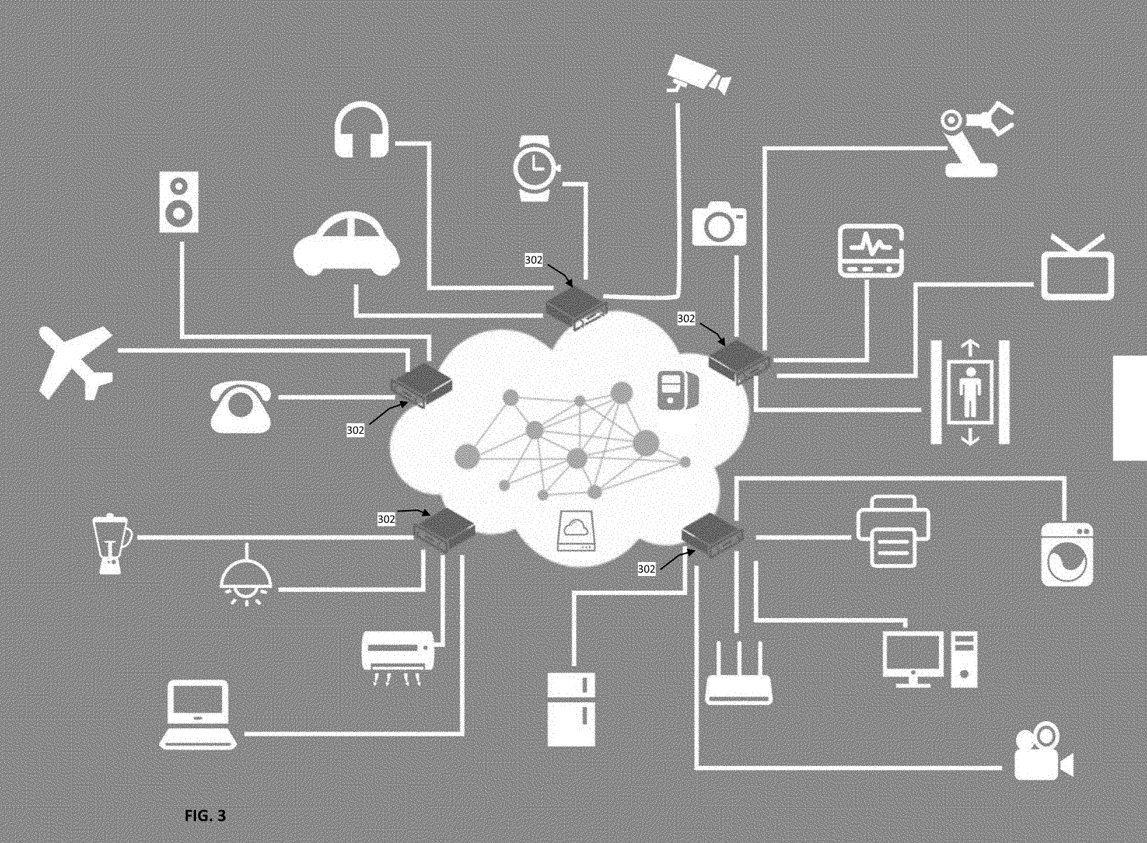

On the edge those gateways and remote clients typically employ the virtual instrumentation such as the TUN or TAP virtual adapter to capture and deliver the VPN traffic through the virtual network interfaces. The TUN device emulates network layer interfaces and operates on the OSI network layer or the Internet layer in the Internet Protocol suite through IP packets. Alternatively the virtual interface can also be emulated as a TAP device, which is an OSI link layer device and operates with OSI Data Link layer packets like Ethernet frames. TUN is used with routing, while TAP is typically used for creating a virtual network bridge. Packets sent by an operating system via a TUN/TAP device are delivered to the application program 240 which binds to the device. This application program 240 may also pass packets into a TUN/TAP device, in which case the TUN/TAP device delivers or injects these packets to the operating-system network stack thus emulating their reception from an external source. In the implementation depicted in FIG. 2C the application 240 uses UDP interface 245 to associate the virtual adapter with a remote service, which can very well use some other network protocols such as TCP. Although the application 240 goes through the network stack 242 to reach relay 212 potentially taking many network hops along the way, for those applications running above the TUN device 250 via the standard platform Socket API 241 the path to relay 212 appears to the local routing logic to only take a single hop. Similarly the Simple Forwarder 231 can also be implemented based on a TUN/TAP device to build the one-hop overlay link among relays, e.g. between 212 and 213. Frequently this is how a network overlay implements its network abstraction through those virtual overlay links based on TUN/TAP devices.

In some service deployment one or multiple virtualized LANs may be utilized to terminate tunnels connecting from remote clients situated multiple network hops away, where all the client traffic is collected through remote virtual adapters and delivered to the service application through a set of tunnels. In the implementations of the present technology this LAN virtualization is frequently used for packet routing and forwarding based on virtual adapters as depicted in FIG. 2D, so constructed such that for exchanging or forwarding traffic the local applications need only to arrive at a routing decision and allow the actual data forwarding to the next remote logical hop to be performed by the tunneling logic. For instance, in FIG. 2D, the actual device or computer system where the services are offered has only a limited number of physical network interfaces 270. Internally, however, multiple tunnels may be constructed to connect to multiple remote gateways or clients which terminate remotely individually as virtual adapters 275, 276, 277, each of which is typically given a virtual interface address by the logic associated with the virtual adapter 280 through some DHCP service. (All the diagrams in the container 289 are virtual components.) Functionally the traffic going to/from external interfaces or remote gateways typically goes through a single virtual interface 280. Between 280 and those remote virtual adapters 275 through 277 a set of virtual switches or routers 281 is provided.

Note that the terms “connection” and “tunnel” used herein denote some transport connectivity between two devices or applications where a series of interrelated data or control traffic may flow in either direction between them. They don't necessarily indicate narrowly a TCP connection and may be implemented above different network protocols, such as TCP or UDP in the TCP/IP stack, as afforded by the actual environment and as per their functional requirements in reliability or latency. Since the technology mainly concerns with the routing logic on the internet layer of the internet protocol stack, the implementation of data tunnels in the implementations of the technology prefers the datagram paradigm of the UDP protocol under which the packets are delivered on the best effort basis without any order or reliability guarantees. In those situations where UDP protocol is not available, TCP may be utilized to approximate the requirement of the internet layer, sometimes with performance penalty. Adopting TCP protocol for realizing some of the internet layer functions may complicate the implementation. For example, all traffic directed to an access relay may come from many different branch gateways, each of which involves different TCP sockets, even though for routing purposes they may be combined as an aggregate. In the case of UDP, a single receiving socket is sufficient to capture all the incoming packets issued by various branch gateways. In the following description of the technology, the UDP protocol is assumed for illustration purposes as the preferred method for implementing tunnels without precluding the possibility of TCP or other protocols as alternatives. Since tunnels are virtual constructs, there are necessary control messages to be exchanged between those two hosts at each end of the tunnel in addition to the data traffic. The control messages may be exchanged out-of-band by utilizing an extra UDP socket at each end, or in-band by going through the same socket pair as the regular data traffic. A gateway may perform protocol conversion between different types of networks or network applications when required.

Some recent technological advances start to invest additional network resources in the core or the data center cloud of the internet in order to gain additional functions or enhanced routing performance. FIG. 2A depicts one such typical infrastructure based on network overlay inspired by the Spines open-source overlay messaging framework and its derivatives. In Spines messaging framework the application clients connect to each other through those servers in the overlay core (referred to as relays generally in the implementations of the present technology) each running the Spines system daemon. FIG. 2B is the diagram depicting the software architecture and components including the Application Client, the Session Interface between the Client and the Spines daemons, the Routing Level components for packet routing and forwarding on the daemon servers, and the Spines Link Level Protocol among all the daemons. Clearly this architecture is dedicated to a specific host system or a network application with an extended overlay networks designed to support various network functions. The infrastructure depicted in FIGS. 2A and 2B is sometimes adopted to construct an IP VPN by extending the Spines client to run on the gateway 302, 211 or remote access clients 230, 232. FIG. 2C depicts a standard Virtual Adapter construct based on the Linux TUN device 250, where its attached application 240 also operates as a Spines client 210 or 211 using Spines Session Interface 220 to reach one of the relays 212 or 213 in the shared network core running Spines Routing Level logic 221 and Link Level logic 222. This architecture of separating the edge devices from the shared core has the added benefit of not requiring any of those edge elements like 211, 230 and 242 to have public IP addresses as long as those relay nodes are publicly addressable. This is also sometimes viewed as P2P architecture.

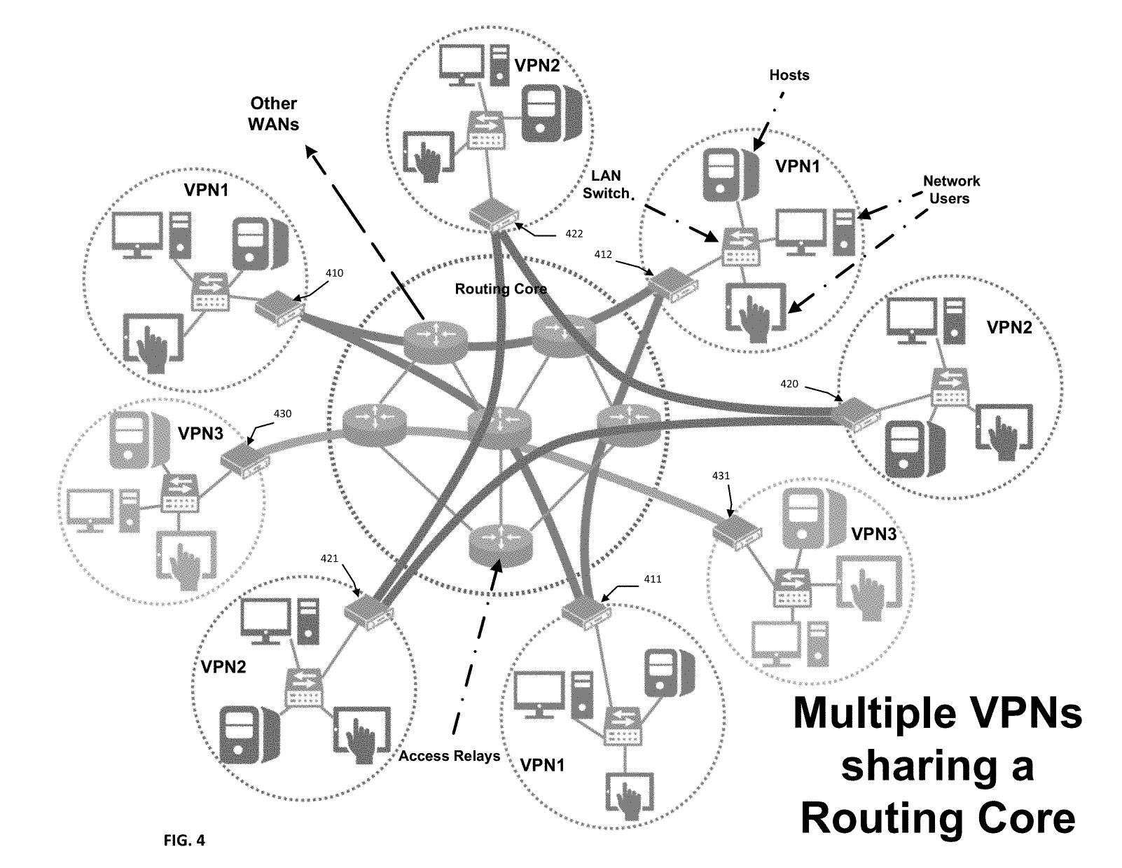

However, this overlay messaging framework of Spines and many other IP VPN frameworks like it lack the capability of sharing the resources built into the network core by multiple participating host systems. The present technology offers a new network sharing method based on which the network core becomes a resource collective sharable among all participating enterprises. Instead of serving a single private VPN, some implementations of the present technology create a shared network infrastructure such that the network core supports not just one VPN but a multitude of logically isolated VPNs. Functionally this sharing of core network resources is similar to MPLS. As depicted in FIG. 4, the shared routing core supports 3 different VPNs, with gateways 410, 411 and 412 functioning as gateways for branches belonging to VPN1, gateways 420, 421 and 422 for VPN2 and gateways 430 and 431 for VPN3, respectively. Those VPNs exemplified as VPN1, VPN2 and VPN3 are logically isolated from each other, unless otherwise configured.

Overlay networks allow easy deployment of new services, as they allow full control over the protocols running among participating nodes. While the Internet provides generic communication solutions that are not tailored to any specific application, an overlay network usually has a limited scope and therefore can deploy application aware protocols. The implementation of present technology presumes a common routing core shared among all the participating host systems. This core may be a dedicated network system comprising of a multitude of dedicated standalone relay servers, or constructed based on an overlay network deployed over the public Internet or a combination of both. Those shared relay servers in the core connect to each other using either dedicated links (leased line or private connectivity) or virtual links based on Internet tunnels. On the other hand, the present technology assumes that the devices or computer systems of individual host systems are divided into non-overlapping branches or sites and each device or computer system accesses other devices or computer system residing in different branches through the branch gateway or gateways which interface with the relays in the shared core for inter-branch connectivity. The technology further allows the accessing to the shared core by individual branches to be dynamic without the need to pre-configure the access relays for each branch.

Some implementations of the present technology implements its new method partially based on an extended version of Spines, which is an open source overlay network that allows easy deployment and testing of overlay protocols. It emulates the OSI network layer traffic closely on top of UDP protocol among its daemons. Spines offers a two-level hierarchy in which applications (clients) connect to the appropriate overlay node (relay) dynamically, and the relay nodes are responsible for forwarding and delivering data to their final destinations through the shared network. Overlay nodes or relays act both as servers (accepting connections from various applications) and as routers (forwarding packets towards clients connected to other overlay nodes). Applications may reside either locally with the Spines nodes or on machines different from the overlay node they connect to.

In order to connect to a Spines overlay node or relay, applications use a library that enables UDP and TCP communication between the application and the elected Spines node. The API offered by the Spines library closely resembles the UNIX socket interface. Each application is uniquely identified by its access socket, a combination of the node ID or IP address of the overlay node it connects to and the Spines Virtual Port which is an identifier for distinguishing Spines sessions from each other. Spines provides both reliable and best-effort communication among end applications, using the application's access sockets in a way similar to TCP and UDP sockets. Similar to the network socket( ) call, a spines_socket( ) function returns a descriptor or handle that can be used for sending and receiving data. Virtual Ports are only defined in the context of a Spines daemon and have no relation to the actual operating system ports. In the following, frequently an access socket is qualified by its intended use as in remote access socket, which indicates the access socket created or defined for a remote access client.

Spines nodes connect to each other using virtual links forming the overlay network. Spines offers a number of protocols on each virtual link, including a best effort service, a TCP-fair reliable protocol and a real time recovery protocol.

One benefit of the two-level hierarchy of Spines is that it limits the size of the overlay network while the routing procedure runs on the higher level with less nodes (only overly nodes or relays) involved, thus reducing the amount of control traffic exchanged. In this two-level hierarchy routing procedure for the core nodes operates on the higher level based on the addresses and subnets expressed in the hyper address plan. An alternative and simpler approach would be to install the Spines server software on all the branch gateways as well and to let those gateways participate in the routing protocol extended from the shared core, in which case all branches are individually addressable without the need to proxy the routing through an intermediate routing proxy (relay). However, by maintaining Spines' two-level hierarchy the connection of branch gateways to the core is afforded the flexibility of operating on an address plan different from that of the core. For instance, the high level of the hierarchy for routings in the core may run on IPv6 or on a dual stack of both IPv4 and IPv6 while the lower level connectivity between the relay and the branch gateways runs on IPv4. Since these two approaches, one-level or two-level, are functionally equivalent, they will be used interchangeably in application scenarios when an application wants to reach another application residing on a specific branch gateway. In scenarios where the branch gateway supports only the base address plan while the routing in the core needs to operate on the hyper address plan, the two-level hierarchy is assumed.

In some implementations, it is assumed the two-level hierarchy of Spines is adopted and modified such that the routing of branch gateways to relays is maintained on the base address plan of IPv4 and the core routing is on the dual stacks of both IPv4 and IPv6 of the hyper address plan. Each application is uniquely identified by its access socket, namely the ID or the IP address of the overlay node it connects to on the base address plan, and its Spines Virtual Port. In other words, the services residing on core nodes listen and accept connections from branch gateways through the IPv4 network stack and the interconnectivity among core nodes through the dual stack of both IPv6 and IPv4.

In some implementations, for a particular host system to participate in sharing the network core all its private branches make their presence known to other network elements in their own private host system or in other host systems in the extranet scenarios by dynamically advertising their identities and their embedded subnets via the relays within the routing fabric, with or without requiring pre-defined configuration. The process of correctly discovering the first appropriate access relay and reporting its presence along with its locally attached constituent subnets is called registration. In response, the relay “redistributes” the knowledge of its recently learned subnets reported by the registering gateway to all other relays in the core. It also lays the supporting framework for all other gateways to communicate with the registering gateway in a P2P fashion without requiring public IP addresses for those gateways. The support for the configuration-less joining of VPN branches to a host system greatly increases host mobility by minimizing configuration requirement on the branch gateways and relays, so one can deploy and relocate any branch, anywhere. Part of the gateway registration process is to support the propagation of branch subnet definition (“redistribution”) such that the subnet configuration defined for the branch is made known globally through the routing protocol after the successful registration. The packet delivery method of Spines is further extended such that at the relay all arriving packets not addressed specifically to any Spines application are de-mapped and checked to see if they are destined to a subnet declared by any locally registered gateway. If they do, one of the identified gateways is selected for delivering to the branch. To assist the delivery of packets to locally registered gateways and branches, all subnets are managed on the relay through the Subnet Tunnel Table. Each entry records the subnet, its VPN ID, branch ID, and other local information for ease of access such as the virtual adapter ID leading to the identified gateway.

The present technology assumes that the participating VPNs intend to interconnect their private branches through the shared routing core, even when the destination may be directly reachable through other means without involving the routing core, for the following reasons:
The routing core has better network resources, such as shorter path or wider bandwidth, or
The destination branch may not have public IP addressability. It may be a private non-routable subnet, such as 10.1.0.0/16.
The connection to the relay in the routing core is encrypted and the connectivity in the core is protected and not visible to unauthorized personnel or machines. The users in the initiating branch want their privacy protected. The routing core may offer Onion Routing to further enhance privacy.

In other words, all inter-branch accesses by participating VPNs are proxied through the shared routing core by first having individual gateways tunnel to one or multiple relays in the core.

In the application scenarios of public Internet access, notwithstanding the dispersed nature of the public hosts or web sites, the Internet as a whole may be treated as a single logical branch with all the relays as default gateways which have no need of registration. Under these scenarios the distance or metric to this default “Internet branch” is set to the maximum for routing purposes without further differentiation. In other words, all relays can be outlets for accessing the Internet with no preferences indicated. However, with extra resources dedicated to the shared network, some parts of the public Internet may be singled out and bundled with some specific set of relays which may be preferred over other relays as the access gateway due to their bandwidth or latency advantages. This favoring of certain relays for certain set of Internet addresses prompts the partitioning of the public Internet into various logical branches, the addresses of which may be redistributed separately from the rest of the Internet. The redistribution metric of those blocks of addresses may be manually set or measured in real time with frequent adjustments to redistributed subnets.

In computer networks, a “tunneling protocol” allows a network user to access or provide a network service that the underlying network does not support or provide directly. One important use of a tunneling protocol is to allow a foreign protocol to run over a network that does not support that particular protocol natively; for example, running IPv6 over IPv4, or running IPv4 over IPv6 in some implementations of this technology. Another use is to provide services that are impractical or unsafe to be offered using only the underlying network services; for example, providing a corporate network address to a remote user whose physical network address is not part of the corporate network. Because tunneling involves repackaging the traffic data into a different form, optionally with encryption performed over the traffic, a third use is to hide the nature of the traffic that flows through the tunnels.

The tunneling protocol works by using the data portion of a packet (the payload) to carry the packets that actually provide the network service which is not directly supported by the base network. Tunneling uses a layered protocol model such as those of the OSI or TCP/IP protocol suite, but usually violates the layering when using the payload to carry a service not normally provided by the network. Typically, the delivery protocol operates at an equal or higher level in the layered model than the payload protocol. In some implementations, the technology may be viewed as a tunneling technology or method such that individual host systems may interconnect their geographically distributed branches or sites based on their private addresses and routing plans through the shared network core.

From the delivery perspective, a tunnel is a transport association between two ends, each with packet sending/receiving capabilities, usually residing on separate hosts or devices positioned on different physical networks. It is to implement a data carrying method connecting two end points through heterogeneous network fabric. Packets receiving from one end of the tunnel are to be transported to the other end before delivering to their destination, possibly with protocol conversion before delivery. A tunnel may be either one-way or two-way, depending on its functions. When two-way traffic is supported by a tunnel, the two separate data flow directions may utilize two different transportation methods or protocols without being symmetric. It is typically constructed in such a way that relative to certain transport applications it looks like a single logical hop even when multiple physical network hops are involved. It is also frequently used to create a link between two hosts such that to the routing logic the tunnel appears as a single-hop network link connecting two logically adjacent neighbors.

A tunnel is called a routing tunnel if the delivered output IP packet is identical to its original packet. It is called a proxy tunnel if the delivered packet is modified in order to fulfill the requirements of certain protocols. For instance, for IP protocol, the delivering end of the tunnel may change the source and/or the destination addresses in the Transport Layer headers such that the target servers or services may be discovered if not precisely defined and the response may return to the tunnel instead of the originating host directly for return-route selection purposes. This is commonly referred to as the NAT function. On receiving the return packets the proxy tunnel then, in turn, recovers the original packets before back-tracking to the original source. Note that NAT function would cause issues in situations that the source or destination addresses or ports, namely the modified parts of the packet header, are part of the payload. Furthermore, the delivering of packets within a tunnel may need to follow certain QoS constraints, such as guaranteed delivery, maximally allowed latency, guaranteed ordering of packets, etc. VPN tunneling is a well-established technique in the traditional IP VPN technology. As far as the tunneling goes, among other things, the present technology offers a new encapsulation technique such that the tunneled traffic, based on base address plan, may go through the routing core by mapping into the hyper address plan before entering into the core, terminate at the other end of the tunnel and be de-mapped back to the base address plan before delivering to the target branch.

For a given gateway, exactly which of those relays to register to is policy-dependent, with preferences usually expressed by criteria such as bandwidth capacity of the relays, latency to the relays, locality, admission control, QoS, along with others. A branch may have multiple gateways connecting to different access relays for redundancy and performance reasons. A branch gateway may connect to multiple access relays. For instance, a branch gateway 700 may select a relay 712 for latency sensitive traffic and another relay 714 for cost sensitive traffic through access tunnels 702 and 704 respectively. On the other hand, a relay may act as the access proxy for multiple branch gateways. The logic for a gateway to select and connect to a relay is referred as registration process. The selected relays are registration relays for the said gateway.

Sometimes a “split tunnel” design may be utilized to drop off those packets which gain little in going through the routing core. For instance, some web pages may embed some advertisements which are intended to be retrieved locally other than from where the web origin server actually resides on the remote side of the routing core.

As previously mentioned, there are two types of traffic flowing in the tunnels between the gateways and their access relays: the control and the data traffic. The control traffic is typically for discovering the services in the cloud, authenticating the gateway, declaring branch network composition, initiating or shutting down services, requesting and assigning addresses, among others. The data traffic comprises the actual application data flow in the environment set up by the control traffic. Through the setup by the control traffic, sessions are created between the gateways and their access relays for keeping track of the control environment under which individual control or data traffic flows are guided. The control traffic and data traffic may share the same network tunnels or connections, referred to as in-band, or alternatively have their own separate network tunnels or connections, referred to as out-of-band. In the situations where multiple tunnels, such as 905-907, exist between a gateway and a relay, the control session may go through one or many of those tunnels. The end point of a session at the relay may be identified by the pair of the relay and a virtual port, which is herein referred as the access socket with its associated Spines virtual port as the access port, as previously mentioned. The access session is similarly referred to and identified as the access session or tunnel, comprising multiple TCP connections or UDP sessions.

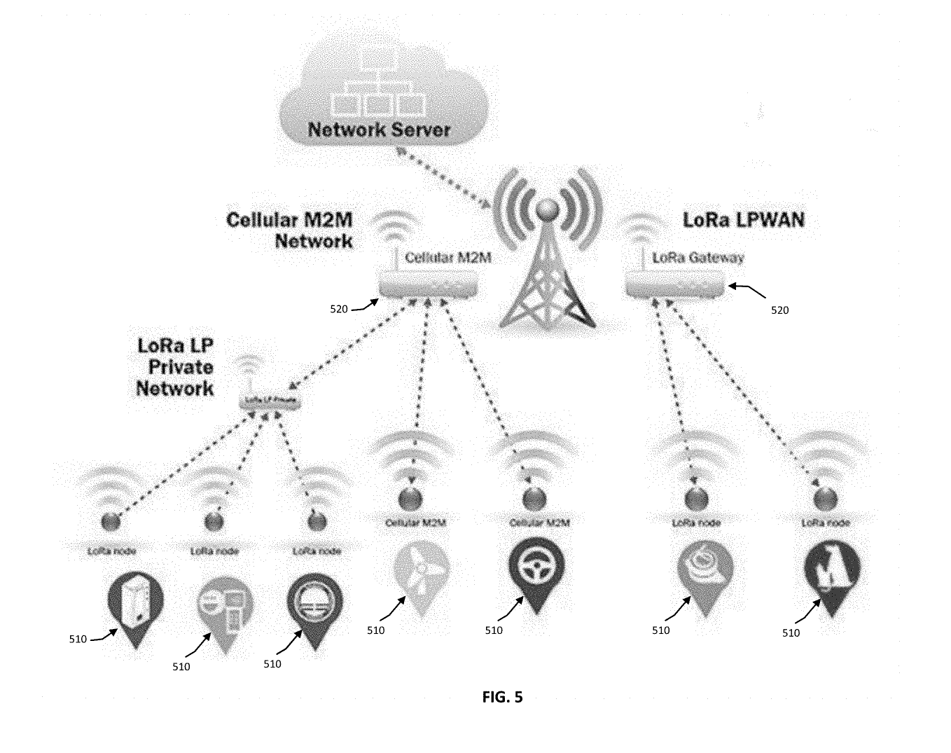

The branch of a host system is not necessarily confined to a location with well-defined boundary. It is a group of hosts or devices, each of which is connected to its gateway through some communication means but may be distributed geographically over a broad span of areas. The cross-connectivity among hosts or devices within the same branch may not be required, depending on the relevant applications designed for the branch. An example “branch” is depicted in FIG. 5, with a large number of data collecting devices 510, connecting to the data-concentrating gateway 520 through NB-IoT or other types of IoT wireless means over a considerable span of distances. In some implementations where the security concerns are highly critical, disallowing cross-connectivity among devices in this application scenario may be enforced to reduce the attack surface.

Outline of the Technology

In a VPN service such as MPLS, all participating VPNs share the same core routing fabric or cloud. The traffic destined to a remote branch is injected into the shared cloud by the gateway, which in turn routes them to their intended destination branch or remote access client. MPLS employs special-purpose PE routers in its cloud for accepting traffic flowing toward the cloud from various branches coming from their respective VPNs. Packets from different VPNs are differentiated in the core by prefixing a label over them before sending them off. This label switching technique is not part of the IP protocol, hence the need for non-IP MPLS routers in the MPLS routing core. The present technology creates a traffic differentiating method which transports traffic from individual private networks to their destination in their respective VPNs while sharing the same core routing fabric or cloud. The aggregated traffic flowing in the core still conform to IP protocol so that standard IP routers can be utilized for routing within the core. The routers utilized in the present technology in the core are those access relays previously mentioned. In other words, while MPLS for IP clients or applications provides network sharing by running IP protocol over label switching core, the present technology running IP protocol over IP core. This approach has the benefits that all standard IP routing hardware is directly usable and all IP based technology, such as segment routing, ECMP, MP-TCP tunnels, etc., are directly transferable to the implementations of the present technology.

Devices or hosts in a VPN are normally interconnected through an interior packet routing scheme based on a consistent address plan. However, two different VPNs may overlap or intersect over some constituent devices for extranet (or inter-VPN) communication, in which case in some implementations those intersected devices are assigned with identical addresses by their respective VPNs for practical administrative convenience. Hosts engaged in extranet communication use those intersected devices to store and/or forward packets across VPN boundaries. Since those intersected devices are usually grouped into an extranet branch shared by multiple VPNs, most of the network accesses are still intra-VPN but with those extranet branches owning multiple VPN IDs.

In summary, this technology can apply in several scenarios:
1. The construction of IP VPNs over a shared common routing core; each of the VPNs is logically isolated from each other in terms of address plan.
2. The remote access by a remote client host connecting to its selected private VPN.
3. The extranet access through overlapped/shared base addresses.

In some implementations, one objective of the technology is to allow each VPN to adopt its own private address plan and routing scheme autonomously, not interfering with or interfered by other VPNs, and to allow the shared routing core to use the standard IP routing logic so that the shared routing core may be built on top of the Internet as an overlay, unlike the MPLS that requires special non-IP routers in its core. For example:
1. For individual host systems, adopt an IP address plan (the base address plan) sufficient to address all of the devices or hosts of significance to a set of applications to be applied in individual host systems. The traditional techniques of NAT (Network Address Translation) and protocol conversion may be applied to extend the addressability for those hosts not part of the base address plan throughout the host system.
2. Adopt a hyper address plan large enough to contain the total number of potential addresses to be utilized by all the devices or hosts from all participating host systems.
3. Utilize an embedding method such that the addresses of hosts from individual host systems map into their counterparts in the hyper address plan and can later be recovered by de-mapping from the hyper address plan back to their original base addresses. After the mapping into the hyper address plan, individual host systems embedded in the hyper address plan maintain the same consistency of their respective base address plans as subsets of the hyper address plan. Individual base address plans only cover those network elements on the interior side of their respective access gateways, not necessarily including the shared network core or any of the access tunnels.
4. A shared routing core is constructed in such a way that individual host systems may interconnect their branches through it. It also allows for remote clients to access individual host systems. Routing in the shared routing core may be based on the addresses either in the hyper address plan or in the base address plan specifically for covering the shared core.

In some implementations, another objective is to cover each VPN with an independent IPv4 address plan, with static or dynamic routing independently implemented by each VPN, and to deploy an additional IPv6 addresses for the hyper address plan with the network core running dual-stack supporting both. Logically, those VPNs operate independently from each other. Overlapping devices among VPNs are allowed for extranet applications when a set of devices or hosts are accessible by multiple VPNs. As mentioned previously, those overlapping devices desire identical base address assignment in all the VPN branches containing them for administrative convenience.

As a contrast to MPLS, the technology is based on a software gateway function (counterpart of CE in MPLS) installed on each gateway elements in all the VPN branches, which can also be installed into various clients for remote access, with all the relays in the cloud playing the dual role of traffic concentrators and backbone routers, similar to the PE and P routers in MPLS.

Another desirable feature of the technology is the mobile nature of the address assignment. The registration of a branch gateway from a particular VPN to the core may be completely dynamic, possibly with multiple gateways each with multiple connections to separate relays in the routing core for redundancy and reliability. There is no pre-arrangement required and no PE to re-configure for the migration of branch sites.

The Routing Architecture

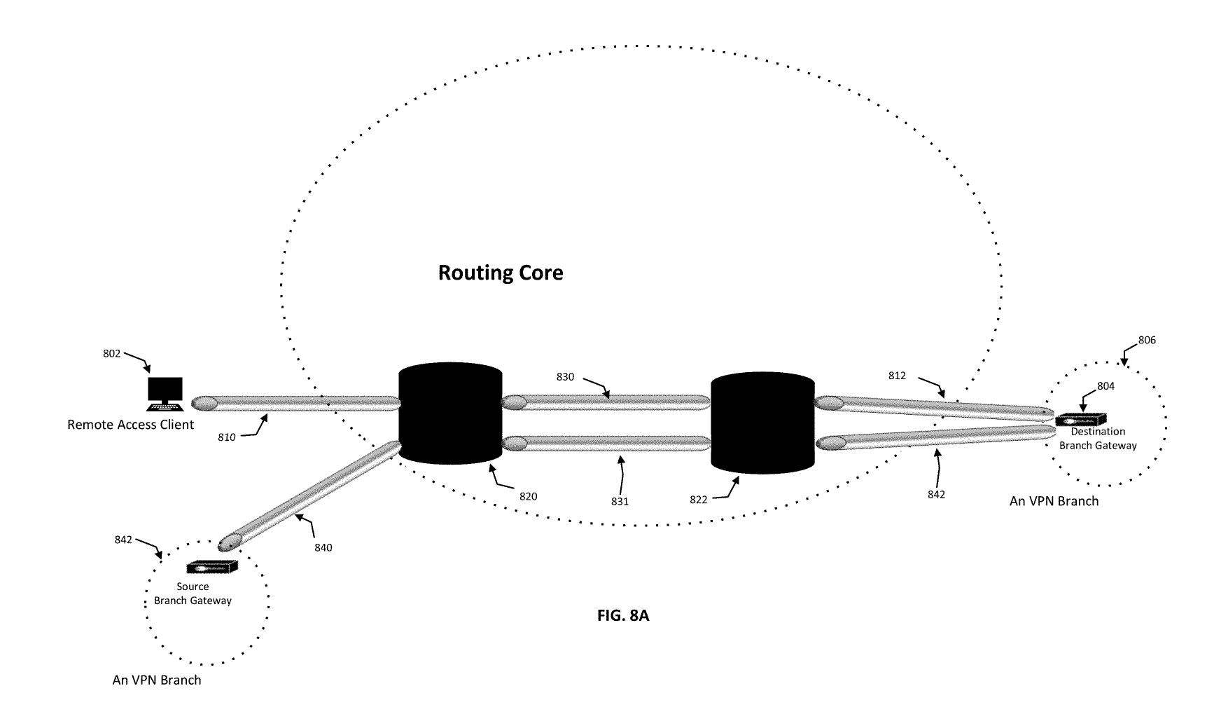

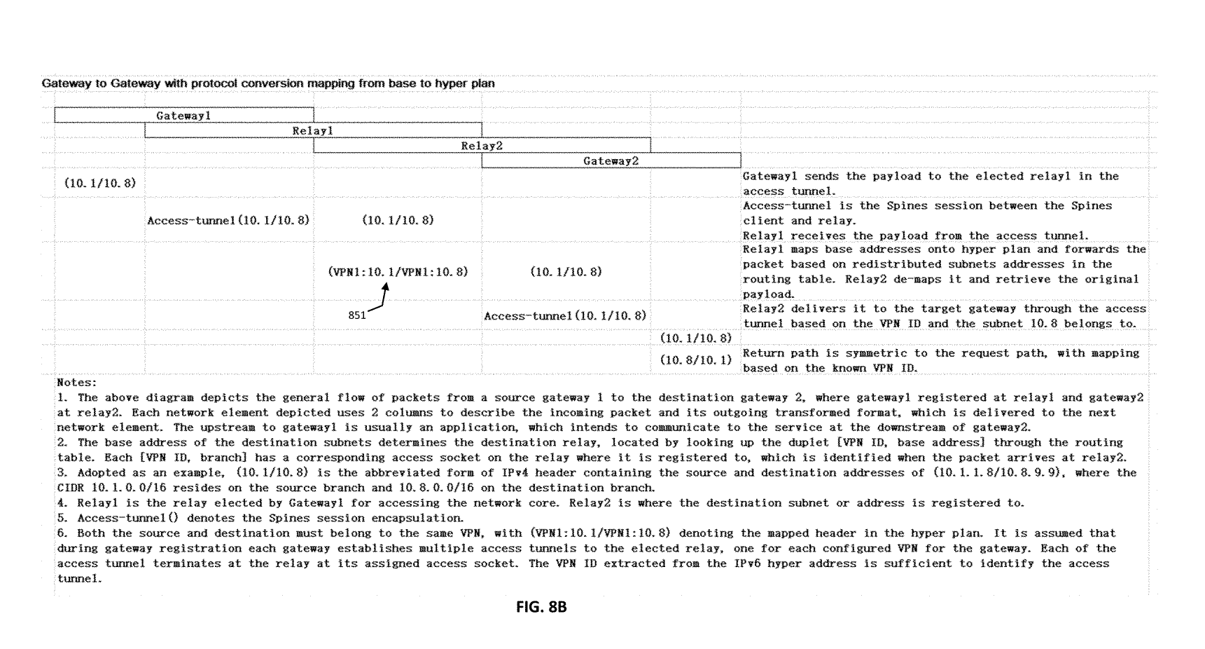

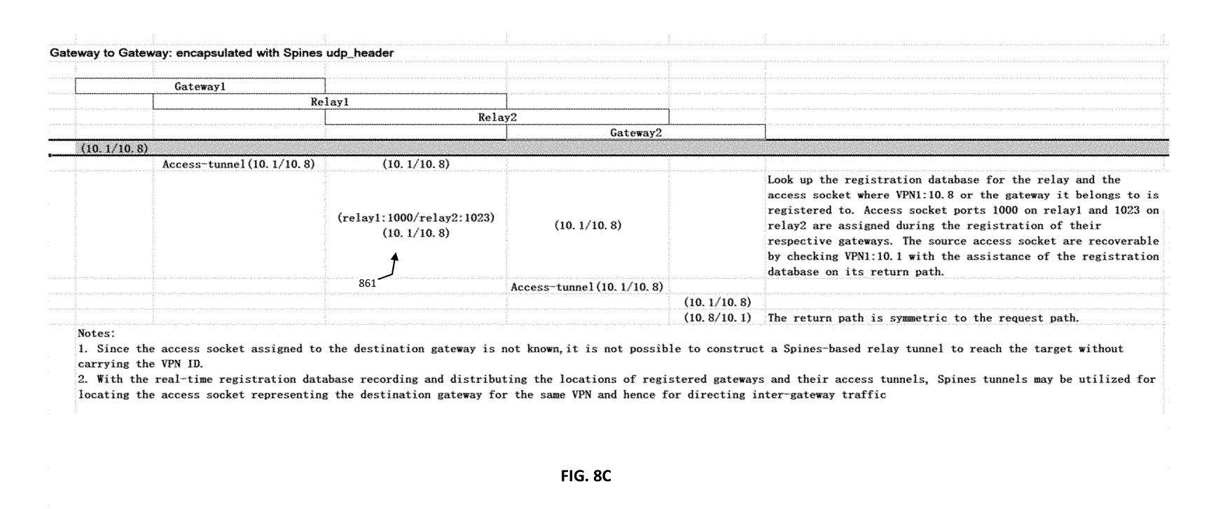

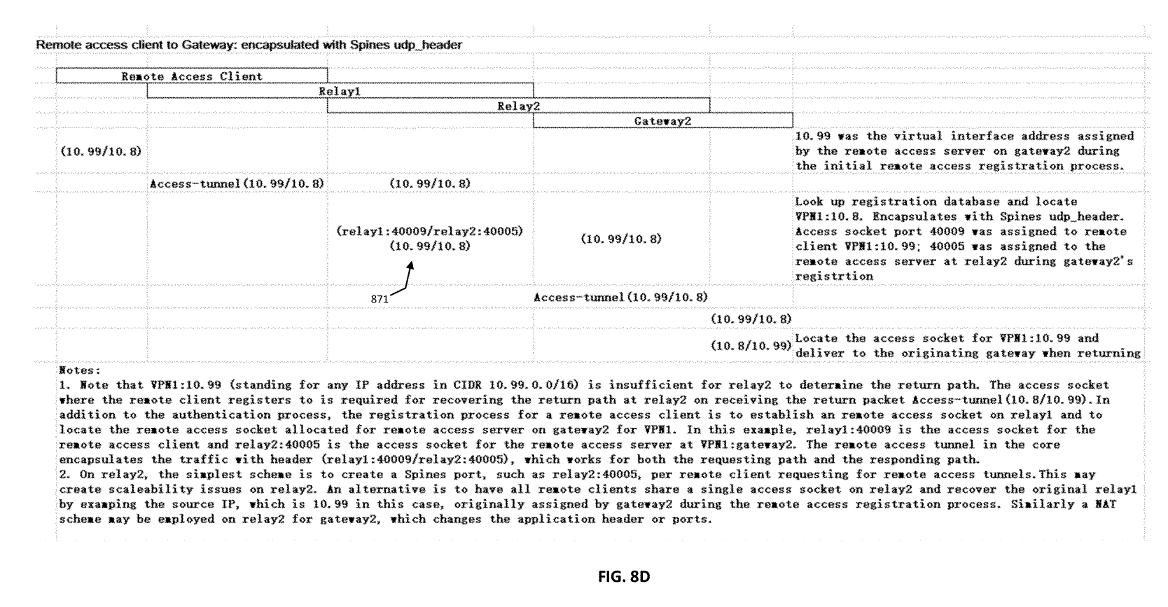

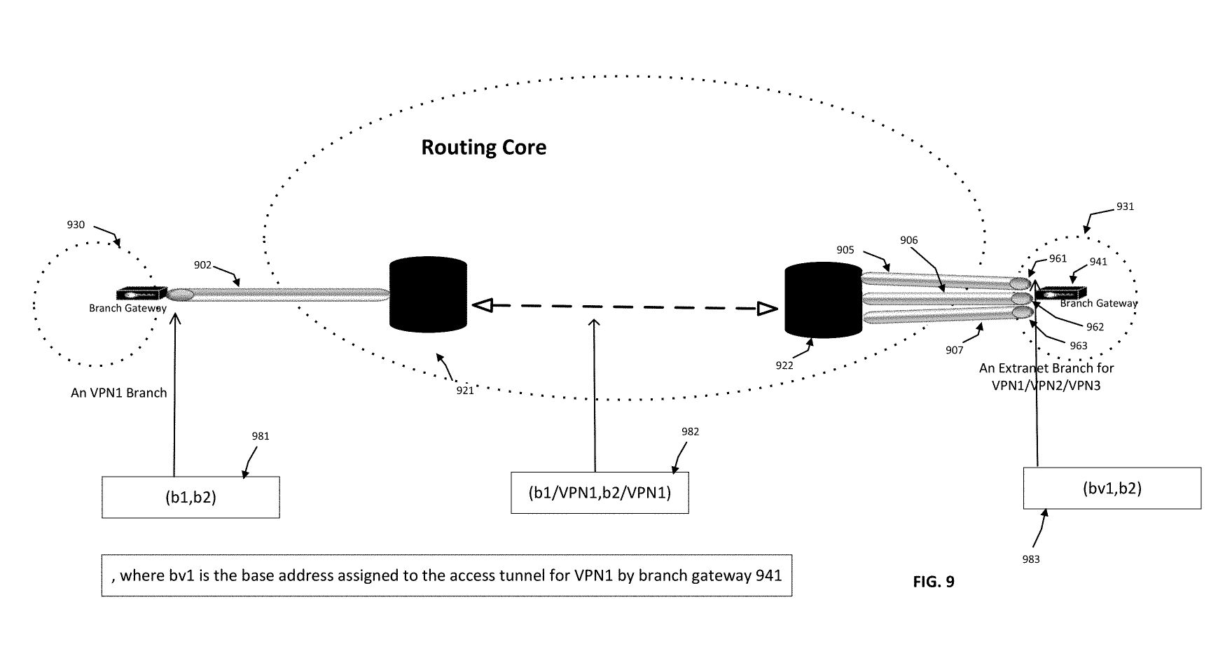

The current technology is further detailed as follows:
1. There are two levels of address plans employed in the present technology: the base address plan (or base plan for short, containing all its base addresses), adopted by each participating VPN, and the hyper address plan (or hyper plan for short, containing all its hyper addresses), which is wide enough to contain all the base address plans as non-overlapping subsets and all the routers in the core. Individual participating VPNs are assigned with unique VPN IDs with their sites or branches assigned with unique branch IDs. Each host or device within a specific VPN is uniquely identified by the duplet [VPN ID, base-address], where the base-address is any one of the unicast addresses assigned to the device. There is a one-to-one function which maps the base address into a unique address in the hyper address plan. In the following description of the technology, the duplet and its mapped-to address in the hyper address plan are sometimes used interchangeably where there is no danger of confusion.
2. For transporting a packet, the source VPN ID and the destination VPN ID are usually identical. However, it does not preclude the possibilities of their being different for certain application scenarios, such as for extranet or public Internet accesses. In the case of extranet access wherein multiple VPNs share some overlapping devices or hosts, there will be multiple addresses in the hyper address plan pointing to the same set of devices.
3. Each branch gateway has one or more interior network interface which are assigned with addresses in the base address plan and at least one exterior network interface which is assigned with a provider interface address for passing traffic into and/or out of the public Internet. The provider interface address is only used for tunneling into the relays and independent from both the base and the hyper address plan. The relays in the network core have their own address plan, supporting dual stacks for both the base address plan and hyper address plan.
4. Each relay is assigned with at least one provider interface address and at least one address in the hyper plan. The provider interface address is used by the branch gateways to connect in.
5. The hyper address plan further provides a global routing function to all mapped addresses, with the relays as leave nodes that redistribute addresses or subnets from all locally registered gateways. In other words, when a VPN branch registers itself to the routing core through one of its gateways, its addressable branch subnets on the base plan are mapped into those subnets in the hyper plan and made known to all the relays through the propagation scheme of a routing protocol (e.g. through OSPF). A corresponding cleanup action is performed when the VPN branch detaches itself from the core or no longer connected or reachable. Note that all the addressing methods, such as unicast, broadcast, multicast, anycast, geocast, etc., supported in the base address plans are all supported by the hyper address plan, or otherwise functional limitations can be imposed for those missing functions.
6. There is a global configuration definition store or database for specifying the layout for each branch of the VPN in terms of its subnets, individual gateway configuration, credential directory for authenticating and authorizing administrators, and access control list (firewall rules or filters) for all the gateways and relays. It also contains similar information for a remote client to access the selected branch of any VPN. This configuration database is directly accessible by all the relays and indirectly by the gateways in the implementation of the present technology. It may be constructed as either a centralized or a distributed data store, implemented in traditional database management systems or in NoSQL. Gateways and remote clients are usually not allowed direct access to this database except the information for identification and authentication necessary to discover the first access relay and to bootstrap the registration process.
7. In order to access a particular address within a VPN from one of its branches, the requesting device can first identify the intended VPN by implicitly or explicitly supplying their VPN ID in order to utilize the shared routing core. The elected relay in the routing core accepts the packets from their originating VPNs, maps the source and destination addresses based on their respective [VPN ID, base address] duplet into their counterparts in the hyper address plan and sends them off to the destination relay. The packet eventually reaches the relay where at least one of the gateways of the destination branch of the target VPN is registered. This transport of messages may be carried out either through protocol conversion, which translates the routing header from the base address plan into the hyper address plan, or through a tunneling method by adding an extra routing header defined for the hyper address plan in front of the original packets. Before delivering, the addresses in the hyper address plan are de-mapped to its original format. The original packet is recovered and then delivered to the target host or device through the access tunnel going to the identified gateway.
8. Adopting the standard IPv6 as the hyper address plan in the routing core allows the packet to be routed based on any standard IPv6 routing protocols over any standard computing platforms, which presumes that all packets to be routed through the routing core are prefixed with IPv6 header. However, if the routing core is self-contained without compatibility issues, the IPv6 header may be abbreviated in a non-standard short hand as long as the source and destination VPN IDs are carried within the packet, either in the abbreviated header or the payload.
9. Prior to the delivery of the original payload with IPv4 header at the destination gateway, a NAT function may be applied (by the access tunnel as a proxy tunnel) in those extranet application scenarios where the return route to a specific VPN may be indeterminable without the NAT. In some implementations, the mapped source address in the hyper plan is not critical inside the routing core as long as the return packets may be uniquely mapped to their originating relay. It may be used to keep the context of the originating packets if some routing session needs to be maintained for functional or performance reasons.
10. Architecturally the implementations of the present technology assume the capabilities of constructing any number of end-to-end tunnels connecting a gateway or a remote access client to any other gateway. As depicted in FIG. 8A, a tunnel is typically comprised of an access section 810, 840 for registering the remote access client or source gateway and accessing the core, an intra-core section 830, 831, and a destination path 812, 842 from the relay, where the destination gateway is registered to, to the gateway. Each section typically involves multiple hops. Notwithstanding scalability issues, each tunnel constructed as prescribed above carries the source VPN ID and destination ID. With the help of NAT when needed, the traffic may be routed from the source location 802 or 842 to their destination gateway 804 with the return responses correctly routed back to their originated location from their destination. When the source VPN ID and destination VPN ID are the same, the access path 812 and 842 to the destination gateway may be processed in the same fashion in order to save the considerable amount of resources required to support those tunnels. For gateway to gateway routing, the middle section may be completely implemented by the routing in the hyper plan as the VPN ID and base address together is sufficient to figure out the path bi-directionally.

Mapping Base Addresses into Hyper Addresses

The routing logic for the core is based on the hyper address plan. In the implementation where IPv6 is the adopted hyper address plan, most of the IP routing technology like IS-IS, OSPF, Babel, RIP, etc. would work well in the core functionally, including optionally those extensions such as source-sensitive routing or multi-dimensional routing with QoS considerations. Depending on the application classes of the traffic, the core may maintain multiple routing tables for different classes of services. The special handling offered by the present technology includes the mapping method at the edge of the routing core and the construction of IP tunnels.

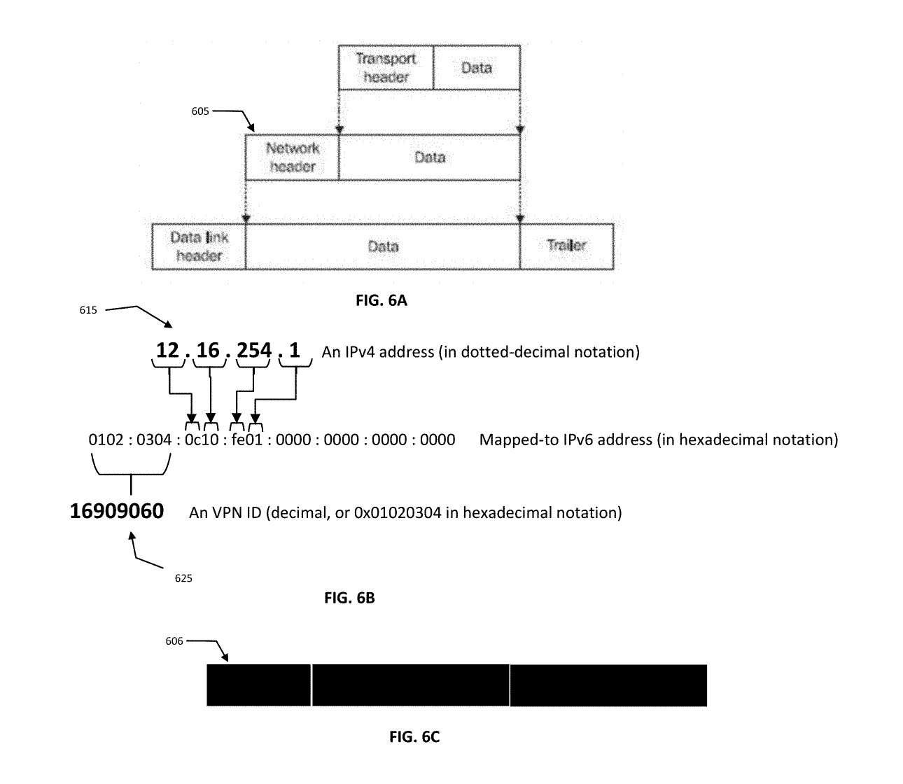

In some implementations adopting IPv4 address plan as the base address plan and IPv6 as the hyper address plan with a specific embedding scheme is described in the context of Internet Protocol suite outlined in FIG. 6A, applicable to both IPv4 and IPv6, and by an mapping example in FIG. 6B. The access tunnel between the branch gateway and the relay is utilized to direct all relevant traffic among the branches. The access tunnel is where the mapping or conversion between the IPv4 and IPv6 addresses takes place. The access tunnel ends at the access tunnel handler at the access relay. Since usually there are many branches such as 720, 725, 726, etc., that originate from different VPNs attempting to register to the same relay 714, a signaling procedure is required to distinguish those branches by their VPN IDs and the base subnets (subnets in the base address plan) they represent. Some error checking is performed at this juncture to make sure all subnets from the same VPN do not overlap. This signaling procedure may be carried out either in-band or out-of-band. In the case of out-of-band signaling, the data access tunnel is coupled with a control tunnel. After the successful initial signaling session, different tunnels from different branches are differentiated typically by the TCP socket if TCP is used to build the tunnel, or UDP source IP and port if UDP is used. The logic of embedding can be carried out either at the branch gateway or at the access tunnel handler at the relay. Packets flowing out of the relay end of the access tunnel are ready to be routed in the routing core based on the hyper address plan. The same tunnel is also used to deliver incoming packets to the branch with the de-mapping function performed at either end of the access tunnel. The tunnel may be created either on the IPv4 or on the IPv6 address plan.

If the IPv6 addressing convention is followed, the IPv4 source or destination addresses 615 in the network header 605 are embedded into the second 32 bits of their corresponding IPv6 network addresses, with the leading or most-significant 32 bits used to carry the VPN ID 625 in order to identify individual VPNs. The primary purpose of this embedding scheme is to enable the routing to and from hosts among individual VPNs and to isolate individual VPNs from each other except for the extranet scenarios. If the shared routing core is to be constructed out of an overlay network built on top of the Internet, the hyper address plan for the shared core would be self-contained. However, to avoid possible interference or confusion between the shared routing core and the general Internet, some implementations may exclude from the mapping scheme the mapped-to addresses those IPv6 addresses for special allocation, multicast, link-local, site-local addresses and other IPv6 special non-unicast addresses. The practice of subnetting in the base address plans is naturally extended to the hyper address plan by incorporating the subnet prefix with VPN ID as the leading prefix. Note that the address assignment for the VPN branches is usually done statically, typically involving some address plan planning prior to its deployment, whereas the remote access clients are usually dynamically assigned with temporary addresses during their login process for their intended sessions.

As IPv6 has a much larger address coverage than IPv4, after the embedding all branches and mobile devices originally belonging to different VPNs or shared by multiple VPNs are now turned into individually identifiable branches and mobile units without duplicating addresses among VPNs except for those devices in the extranet scenario when a set of devices is shared by multiple VPNs, in which case the duplet [VPN1, base address] and [VPN2, base address] actually point to the same device bearing the common interior address belonging to both VPN1 and VPN2.

One of the constraints of this embedding scheme is to not overlap mapped addresses from different VPNs in the hyper address plan after embedding, except in the extranet scenarios mentioned previously. For example, the mapped addresses may be less than 32 bits assuming the total number of actual addresses is small enough to fit into the hyper address plan in less than 32 bits and leaves some leading unused bits for other purposes. Similarly, the VPN ID may occupy less than 32 bits as well. On the other hand, if the base address plan requires more than 32 bits to capture its total address range, the mapping would correspondingly take more bits in the hyper address plan, with reduced number of supported VPNs as the consequence. This scenario would arise if the base address plans are also in IPv6, which is to be fitted into an IPv6 hyper plan. Under this scenario, the base address plans may be constrained to leave room in the leading bits of the IPv6 network prefix for VPN IDs or apply some address compression technique to create rooms in the leading bits. In aforementioned implementations of address mapping schemes there is only a single routing and forwarding table is needed for all the participating VPNs. However, if the base address can't be conveniently embedded in the space allocated for hyper addresses in the packet header, the network packet 605 may be encapsulated in a specially designed VPN ID header 606 at the front for this purpose as in FIG. 6C. For the implementations in IP network packets, the Version field takes a value not 4 (IPv4) or 6 (IPv6), with two follow-on VPN ID fields, one for Source VPN and another Destination. In this case the packet is no longer in IPv4 or IPv6 format and this private VPN ID header can be de-capsulated so that the destination VPN ID may be determined before the traditional IP routing logic may be executed. Multiple routing tables may be adopted to accommodate the variety of VPN IDs.

All addresses in the hyper address plan are routable if an appropriate routing scheme is selected for the hyper address plan. The present technology supports all dynamic routing scheme, like RIP, IS-IS, OSPF, big, Babel, etc., within the routing core such that individual VPN branches or remote clients may be dynamically registered or de-registered to the relays in the shared routing core with the hyper subnet addresses of the branches dynamically redistributed to all other relays to establish their addressability and routability within the core. It further supports the registration of branches and remote clients to be mobile, not necessarily to the same pre-configured pre-designated core router (like PE in MPLS). This mobility afforded by the present technology is a highly desirable feature, especially the mobility of the remote clients. For those non-IP networks, such as MPLS, the remote access from a client roaming around on the Internet would be complex and require much pre-configuration and planning (for the PEs).

One of the advantages of the present technology is the logical isolation of each VPN from other participating VPNs and particularly from the Internet over which the shared routing core is constructed. Unless it is specifically configured in, such as in the extranet application scenario, individual host or device in any VPN does not offer addressability to parties outside of it private VPNs. This protection from unwanted access is particularly critical for insulating the VPN from the public Internet where the cyber hackings or attacks are usually launched from.

Specifically, implementations of the technology typically need a “login” or registration procedure to be carried out by the branch gateway as part of their initial signaling procedure when a VPN branch wants to join a particular VPN through the shared cloud. The purpose of the login is to provide securely one or multiple VPN IDs for the joining branch such that the mapping of their addresses into the hyper address plan can be determined. It also declares its addresses or collection of subnets contained within in order to set up the routing table properly and to validate if there are any conflicts with other branches. In an extranet scenario where a branch belongs to multiple host systems or VPNs, the joining branch can declare multiple VPN IDs such that the devices in the extranet branch may be reached by multiple VPNs. For public Internet addresses or sites, which is accessible to all the relays by all the VPNs, special markings or indications may be employed to indicate their universal accessibility by all the VPNs. Similar techniques may be adopted for popular branches commonly accessible to a large number of VPNs.

Similarly, the client when making remote access to a VPN also requires a “login” procedure for the routing core to determine the specific VPN it wants to enter and to assign an appropriate VPN-specific address to the client if not already done so. For a client making remote access to an extranet branch, one of its sharing VPNs is sufficient to identify the target branch.

If the hyper address plan conforms to the IP protocol, the shared routing core may be constructed as an Internet overlay network. Nodes or relays in the overlay network can be thought of as being connected by virtual or logical links, each of which corresponds to a path, possibly stepping through many intermediate physical links, in the underlying Internet. Overlay networking is a method of using software to create layers of network abstraction that can be used to run multiple separate, discrete virtualized hyper networks on top of the physical network, providing support for new network applications or security benefits. This is useful when the hyper address plan and its required routing scheme are not directly supportable by the underlay physical routing core.

FIG. 8B offers a different perspective for the gateway to gateway traffic flow and protocol conversion at various network elements from what has been described in FIG. 8A for 840, 831 and 842. The original payload, including the TCP/IP header, is preserved. Only the original IPv4 header is converted into an IPv6 header at 851.

Database-Assisted Routing

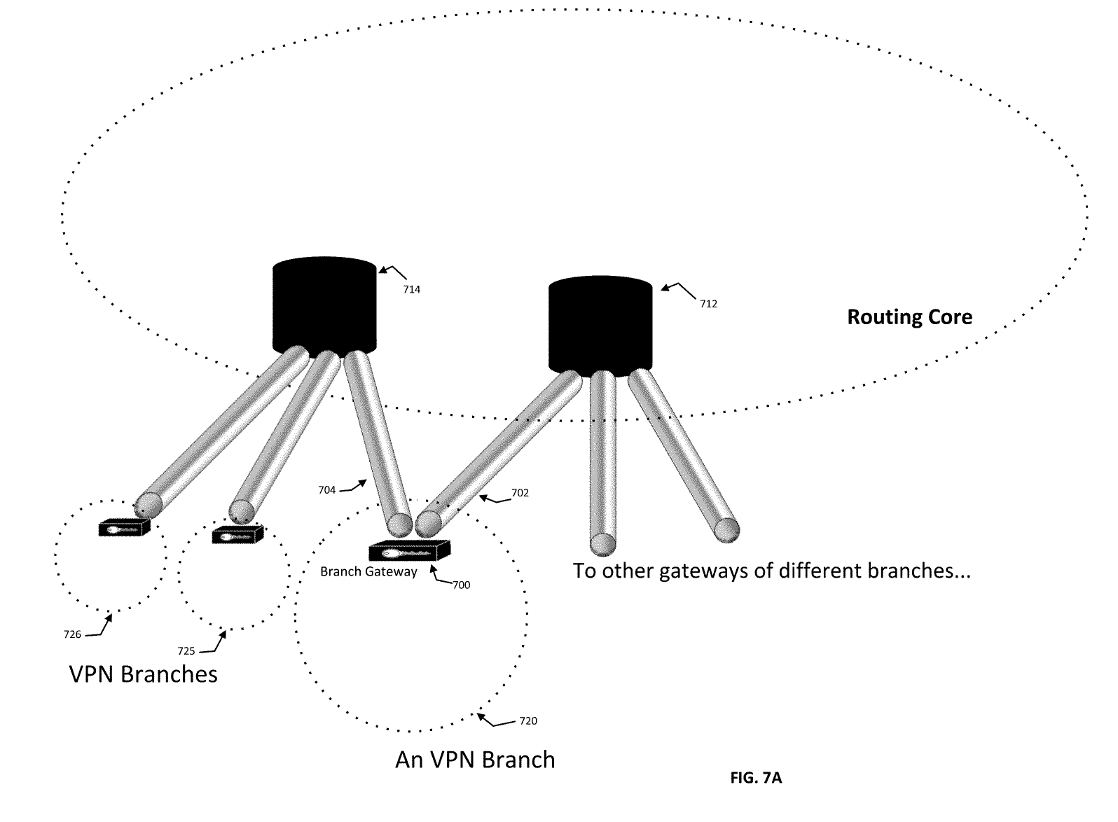

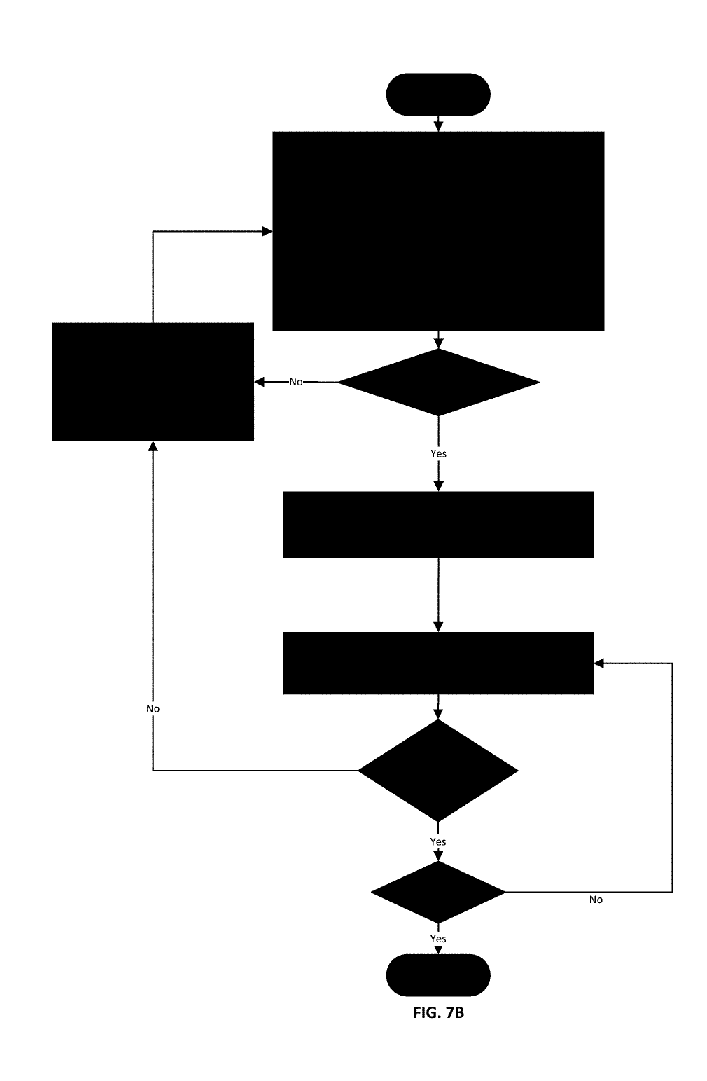

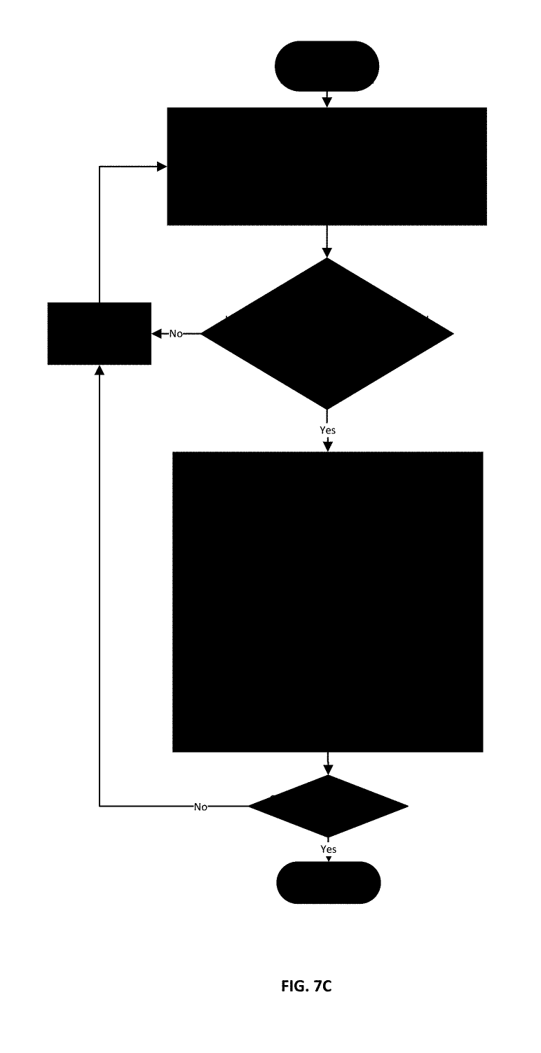

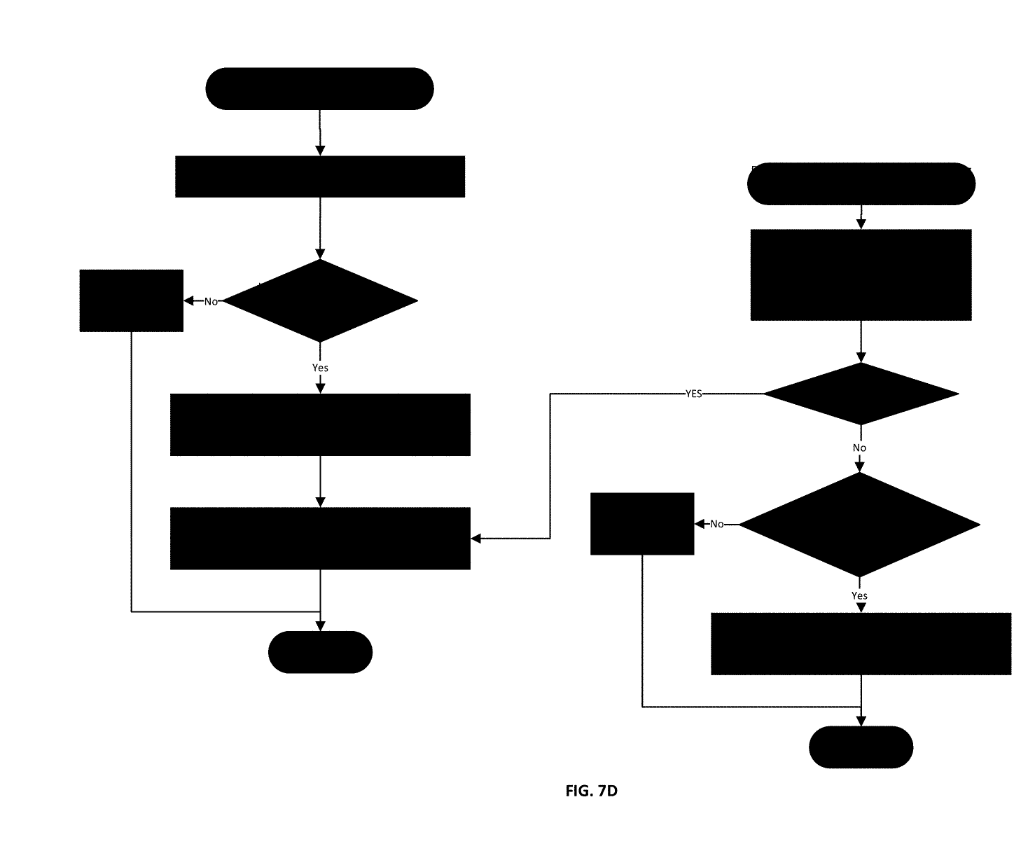

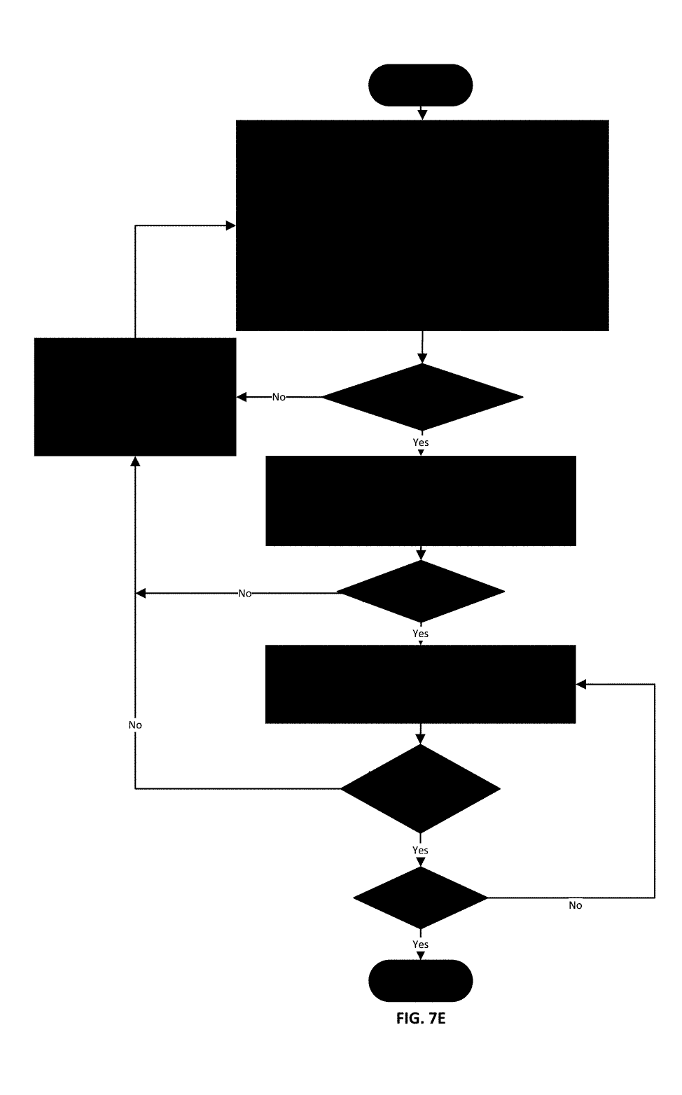

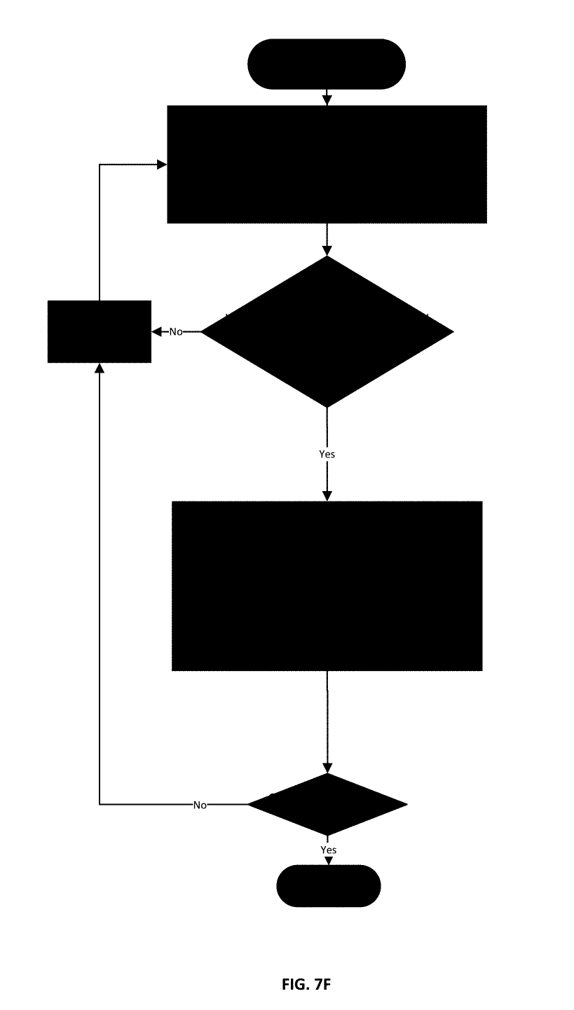

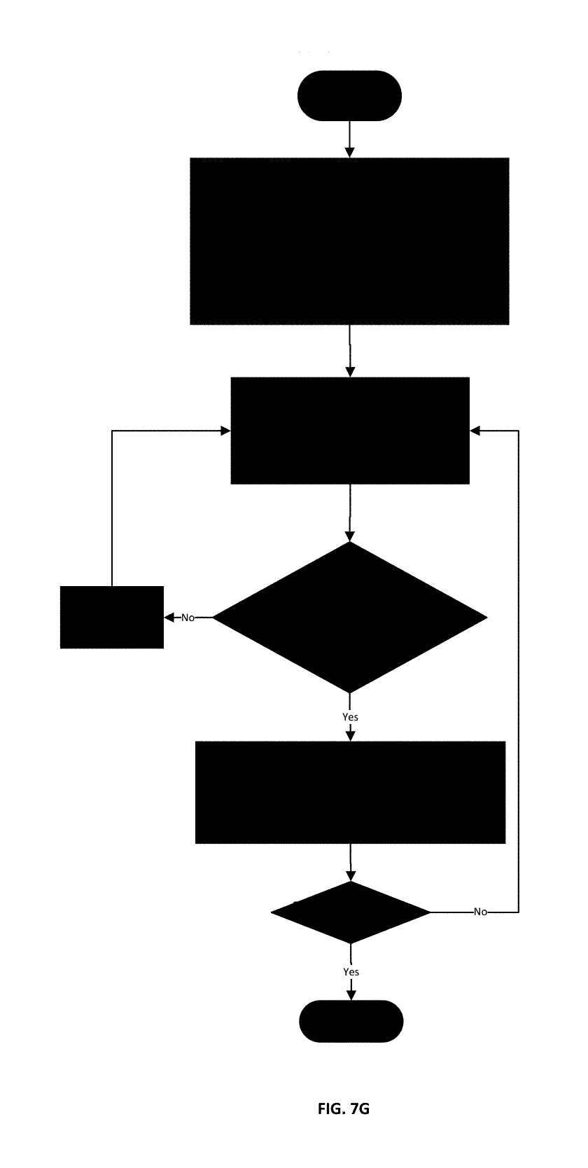

As depicted in FIG. 7B and FIG. 7C, for each defined VPN, a gateway is assigned with an access socket for gateway to gateway traffic and another access socket for remote access at the relay where it is registered to. For a packet to be routed to its destination gateway, the following information can be provided:
The destination relay which the gateway is registered to: The dynamic routing scheme provides this information by examining the VPN ID and subnet configuration.
The access socket: This is discoverable only at the relay locally if the VPN ID of the registering gateway is known.

Some implementations of the present technology employ two separate address plans with the base address plan embeddable into the hyper address plan, as explained previously, depends on the dynamic routing scheme to propagate the reachability and route information of various subnets belonging to different participating subnets. The data traffic destined to a particular gateway is first routed to the relay where the gateway is registered to. The data packet carries the destination VPN ID and base address of the destination, which is utilized at the destination relay to determine how the packets are to be delivered to the gateway by mapping the VPN ID and the type of packets (inter-gateway or remote access) into its destination access sockets.

Alternatively if the destination access socket on the relay allocated to the destination gateway is known beforehand, the sending relay may forward the packet directly to the destination relay through a tunnel mechanism on the base plan without the complication of involving the hyper address plan. For inter-gateway traffic, since the sending gateway is in the same VPN, the return relay address may be discovered by examining the source IP address in the base address plan, which is maintained by the routing mechanism in the core. For remote access, the packet needs also to carry the access socket of the sending relay. This is how an alternative implementation is implemented by recruiting the assistance of an external real-time relay status database, which informs all interested parties about those gateways registered to specific relays and their allocated access sockets. For instance, some implementations may deploy Redis NoSQL database to record all the status changes regarding all the relays, the registering gateways and their assigned access socket ith the virtual adapters running on the gateway per each configured VPN. The relay retrieves the information for each relay from the database for those VPNs it is interested in, and expects the status update information to be pushed in through the Redis Pub/Sub mechanism so that the cached information at the relay is kept current at all time.

An alternative flow diagram for gateway registration and traffic forwarding based on this database-assisted scheme is depicted in FIG. 8C, which offers a different perspective for the gateway to gateway traffic flow and protocol conversion based on Database-assisted Routing at various network elements from what has been described in FIG. 8A for 840, 831 and 842. The original payload, including both the TCP/IP header and IPv4 header, is preserved, prefixed by a tunnel header as depicted by 861 when the packets pass through the shared core.

Remote Access Tunneling

The case for remote access to a specific VPN branch by a remote client is more involved. Before establishing the contact with the target VPN branch, the client usually doesn't have a preassigned base address specific to the target VPN branch which it intends to access. Even if it did and the lone client device was to be handled as a single-device branch in order to apply the same logic as that for a VPN branch, the routing table in the core might not have sufficient resources to support and maintain all those single-device branches in large numbers. However, if the client was not to be handled functionally as a branch gateway in order to obtain its global addressability, the routing scheme in the core could not be relied upon to assist the returning of packets, in which case an end-to-end access tunnel is needed to bridge the traffic from the remote client to its destination branch.

Some implementations may create a packet capturing method on the client host 802, e.g. a virtual adapter on the client device (typically similarly implemented as that on the branch gateway), based on which the first access tunnel 810 is created to bridge the client and the chosen first relay with the controls flowing either in-band or out-of-band. On the other hand, there is a remote access application running on gateway 804 created when it first successfully registers itself to the second relay2 along with one or many remote virtual LAN for anchoring the traffic from remote access client, similar to what was depicted in FIG. 2D. Before the access tunnel may be created, the client goes through the “login” procedure to identify itself as an authorized user for accessing the target branch 806 of a particular VPN or gateway 804 specifically through the routing core. Once permitted to access the core and the specified branch, the remote client 802 would contact the remote access service running on gateway 804 and request for a remote access address on the DHCP server on gateway 804. These two access tunnels on the first and second relays are then bridged together by a tunnel 830 built through the routing core based on the hyper address plan. These three tunnel sections 810, 830, 812 combined forms an end-to-end tunnel between the originating client and the destination gateway through which the destination host or hosts may be reached. The middle section 830 is further detailed in FIG. 8D as 871, with the access socket (relay1:40009) assigned to the first access tunnel from the client to the first relay and the second access socket (relay2:40005) assigned to the second access tunnel from the second relay to the gateway, in supporting of a tunnel prefixed to the original payload for transporting across the share core. Once established, this 3-section tunnel may be made two-way through which the returning packets may be sent via this three-section tunnel in reverse in order to be delivered to its initiating relay and the originating client without relying solely upon the routing core to reach the destination gateway. Note that the routing method in the shared core is utilized only for creating the middle tunnel bridging the first and the second relays assisted by the configuration database. The actual traffic for this remote access application is funneled through the tunnel from either end.

Extranet

To support the general case of extranet the branch gateway should be able to differentiate incoming traffic based on their originating VPN. In some implementations, this is supported by having multiple access tunnels between the branch gateway and its chosen relays, one for each declared VPN to which the branch belongs. As illustrated in FIG. 9A, the extranet branch 931 belongs to 3 different VPNs: VPN1/VPN2/VPN3, which requires 3 different access tunnels 905/906/907 to be created between the gateway 941 and the selected relay 922, one for each of the declared VPN VPN1/VPN2/VPN3 respectively. The data traffic from initiating branch 930, belonging to VPN1, are mapped into the hyper address plan with the source address carrying the VPN1 ID while being routed in the core, which is accepted by the destination relay 922 before piped into tunnel 905. All the access tunnels are proxy tunnels such that the delivered traffic in the branch 931 carrying their originating tunnel identification (905-907), which is used by application at the receiving end of the traffic to return the responses when needed. Note that in the extranet scenario the extranet branch is typically not allowed to initiate data traffic for security reasons. However, if it is allowed to initiate traffic, they will be piped into the appropriate access tunnel based on the destination VPN ID. In FIG. 9A, on the side of the destination branch the implementation creates 3 different base addresses for those different access tunnels, bv1/bv2/bv3 for VPN1/VPN2/VPN3 respectively assigned to their associated virtual adapters, assuming branch 931 is an extranet branch shared by VPN1/VPN2/VPN3. The packet with packet header 981 bears the source base address b1 and destination base address b2 before it enters into the access tunnel 902 from inside of branch 930. For this illustration it is assumed base address b1 is in branch 930 of VPN1, and b2 is in branch 931 also of VPN1 (and also of VPN2/VPN3 as it resides in branch 931 shared between those three VPNs). After receiving the packet, relay 921 maps the routing header into the hyper address plan, which then carries the mapped hyper address depicted in 982 with “bi/VPNi” as the mapped address of bi of VPNi into the hyper plan. As packet 982 reaches relay 922, the destination relay pipes it into access tunnel 905 created for VPN1 after checking the source address in the hyper address plan. As the packet comes out of the tunnel 905, the source IP address becomes bv1 as in 983, which is the result of address translation by the proxy tunnel 905. When this packet is delivered to the destination servers or applications, they have all the information needed to route any returning packet back to tunnel 905.

A different perspective is to consider a gateway supporting multiple VPNs for a particular branch as a collection of virtual gateways, one for each associated VPN. For non-remote access traffic, each virtualized gateway is implemented through a virtual adapter dedicated to a specific VPN. Similarly for remote access traffic, each VPN has its own remote access agent implemented also through a virtual adapter for remote access per associated VPN. For the extranet use scenarios, those virtual adapters may embed NAT function to further assist the application to respond to requests originated from different VPNs.

Before sending traffic in and out of branch 931 the designated VPN ID can be provided to the network layer either explicitly or implicitly, or by sending the packet to one of the access tunnels 905/906/907 with the implied VPN ID. There are many possibilities in implementing the network interface when multiple VPNs are involved in the extranet situation. Other alternative is the use of the NAT function implemented at relay 905 before piping the data into the gateway by segmenting the source ports for VPN differentiation, in which case there is only one tunnel required for all the VPNs. On the branch side, the source port may also be segmented for the same purpose, in that case there is only one gateway address needed for outgoing traffic, e.g., with filters to limit various types of traffic based on performance concerns.

Example Procedures

FIG. 7B is the flow diagram showing the tunnel initiation procedure carried out at a branch gateway for some implementations where the base address plan is IPv4 and the hyper address plan supports IPv6. This is also referred to as the branch gateway registration process. It describes how the gateway of a branch is to establish the access tunnel for a specific VPN ID and branch ID once the access relay is determined and located. As previously indicated, the discovery and determination in selecting the access relays among all the relays in the shared core is policy dependent. There is a higher-level management process or processes which determines the number of access relays to connect to, selects the appropriate relays, initiates the logic described in FIG. 7B per selected relay and manages the up/down status and the restart of tunnels after any connectivity outage. Under the routing logic, the access tunnel is considered one single hop logically. The routing logic and access policies dictate how many gateways would be created or configured for each branch. For instance, if multi-home is supported, there may be multiple gateways installed in the branch. FIG. 7B describes the establishment of the control tunnel, the initiation of data tunnels and the reporting of any connectivity incidents. In the extranet configuration, the initiation procedure described in FIG. 7B will be triggered once per configured VPN to the elected gateway. For a network access initiated by a local host in the branch destined to an address in a specific VPN, that VPN ID determines which one of the access tunnels is to be used for routing. For an incoming network packet, the combination of the VPN ID of the originating branch and the destination addresses determines which one of the access tunnels is used for the incoming visits. Locally on the branch it is expected that all the non-local traffic destined to a subnet of a specific VPN are to be routed to the correct gateway based on a locally administered routing logic.

The port REGISTRATION-PORT, denoting a Spines virtual port on the access relay, is the receptor of requests issued by branch gateways depicted in FIG. 7B and the concentrator of all the data traffic in/out-of successfully registered gateways. The registering gateway goes through the registration process to get authenticated and authorized to send/receive data to/from the relay. The registration command exchanges depicted in FIG. 7B and data passing depicted in FIG. 7D are both carried out in the Spines connection to the Registration Manager (in-band control processing). The Registration Manager listens and accepts requests on port REGISTRATION-PORT that is dedicated to the management and services of the branch registration process. As some implementations of present technology the flow chart depicted in FIG. 7B implements the application 240 in the virtual adapter depicted in FIG. 2C on the gateway. FIG. 7C describes the corresponding registration service servicing for FIG. 7B on the access relay for listening on the REGISTRATION-PORT and receiving the access tunnel initiation request. For ease of description, FIG. 7B and FIG. 7C assume that the control traffic is issued and handled in-band with the TCP based access tunnel. (Spines offers simple extension for implementing the access tunnel in UDP.) The registration manager on the relay server may create simply a single virtual adapter for each requester and let the network layer deliver the traffic to/from branch gateways directly or handle all the requesting gateways as an aggregate to emulate a virtual LAN to all the connecting branch gateways if the resources for constructing virtual adapters are limited for a given application scenario.

FIG. 7D is the flow diagram showing the steps for incoming traffic handling on the relay received from other relays and for outgoing traffic handling on the relay from a locally registered gateway or remote access client. For ease of illustration it starts their steps only after detecting the arrival event for a complete un-fragmented IP packet.

FIGS. 7E and 7F are the flow diagrams showing the remote access initiation and processing steps carried out on the remote client and the elected relay. A remote access client initially carries out a discovery procedure to locate the first access relay and submit the login request as depicted in FIG. 7E and connect directly to the target or destination branch gateway depicted in FIG. 7G, which shows the steps performed on the gateway servicing the remote access requests. The initial steps of registering to the elected relay by a remote access client are similar to the registration process depicted in FIG. 7B with the express purpose of locating the destination branch gateway based on the VPN ID and branch ID. The admission control and authentication may be handled as part of these initial registration steps or delayed until later when the remote branch gateway is successfully contacted.

The remote access function is typically issued against a specific branch gateway as the intended target, the selection of which may be either manual or automatic, based on some remote access policies for selecting the gateway. The elected gateway (the Spines client) becomes a router through which the destination branch may be accessed by the requesting remote clients like 230 or 232. Typically on the destination gateway there are at least two network interfaces, which may be either physical or virtual: one for branch hosts or devices to route to as an interior interface and another for exterior interface to Internet or to the shared core network (typically virtual). The gateway address for the shared network core through the access tunnel is determined by its elected remote relay. However, unlike branch gateways, the remote client does not usually have a pre-configured IP address (on the base address plan of its intended VPN) due to the transient nature of its connection and the routing layer's not being able to scale for the potentially large number of remote clients. The remote client therefore does not have a pre-configured base address (in the same VPN as the destination branch) for the relay node to distribute. Remote mobile clients (mobile hosts or devices) are not bound to its base address (of the destination branch) until after the request is successfully responded by the destination gateway and the authentication validated. In other word, the remote access client is not given a unit-cast address until after its tunnel to the destination branch is successfully established. This remote access tunnel is usually not persistent, unlike the connections between the branch gateway and its relay. Other than the initial discovery of target gateway and the acquisition of client addressability, the establishment of a virtual adapter on the client and its communication to remote gateway, including both the in-band command processing and data exchanges, are architecturally similar to that for the gateways.

One of the application scenarios similar to the extranet situations is the Internet access from inside of a VPN, if we consider the Internet as the shared address space for all the VPNs intending to access it. Under those scenarios, in order to have a consistent base address plan for those VPNs wanting to visit the Internet through the shared routing core, the devices or hosts in the private VPN branches should not overlap their addresses with the Internet VPN. This can be accomplished in following ways:
1. Use only private IP addresses inside the VPN, such as those reserved by the IETF for private networks.
2. Avoid using addresses inside the VPN that are of interests to those intending to access the Internet from the inside, such as addresses assigned to google.com, facebook.com, amazon.com, etc. This is a feasible alternative if those Internet addresses are limited in numbers.
3. NAT

As some implementations of the technology adopt the Internet as the shared core based on an overlay deployment and utilizing the capability of all the relays in reaching any public Internet sites, the access to any of the public sites may be optimized by routing the application packets to those public sites through the shared network taking advantage of the extra network resources afforded by deploying additional bandwidth in the shared infrastructure or adopting alternate paths to less congested routes. For a specific public site, the following optimization technique can be utilized:
1. Make sure that the selected public site does not duplicate any addresses in the base address plan. If conflicts arise, the technique of destination address translation (Destination NAT) may be employed to represent the public site with an address not in conflict with any addresses in the host system for routing segments inside the host system. Configure and measure the RTTs to the specified site from all the relays.
2. For a specific relay, select the shortest path from all candidate routes offered by the neighboring relay nodes plus the first hop distance from the relay to its neighbors. From a specific branch, collect the total path metrics or RTTs from all possible gateways local to the branch, each of which selects its own access relay and discovers the Intra-shared-core RTT to the destination relay through its access tunnel to the selected relay. Determine the relay based on the RTT data collected by the relays and the RTT of the access path to those relays.
3. Select the first access relay based on the shortest collected end-to-end path metric or total RTT.

Traffic Analysis

Based on the present technology the traffic from all participating VPNs can be insulated from each other in the shared core. Additional measures such as encryption and end-to-end key negotiation may be implemented to further offer content privacy for participating traffic flows. Additionally, the network links interconnecting the relays in the core may be independently encrypted so that the original packet headers and their payload of the application flowing within are protected against traffic-sniffing based attacks.

Due to the shared nature of the routing core, the traffic from a particular VPN may be merged in with that from all other VPNs, which makes traffic analysis and traffic signature identification for discovering individual application traffic flows considerably more difficult once the participating traffic from all VPNs reaches a critical amount. Furthermore, the shared core can offer additional services for individual participating VPNs based on the VPN identifiers. For instance, the web push technology (described through the entire specification and claims in U.S. patent application Ser. No. 15/396,086, which is hereby incorporated by reference in its entirety) can be deployed with the push server installed at the destination relay where the application traffic is released to the public Internet from within the share core. Since the application-specific signature is only observable at the second destination relay, independent from the first relay where the original application client registered to, this technology practically defeats all traffic analysis attacks. The shared core may inject cover traffic, implement neutralized or masqueraded traffic frequency or alter the order of packets in the application flows to further obscure the application signatures.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory program carrier for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them. The computer storage medium is not, however, a propagated signal.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous.

What is claimed is:

1. A computer-implemented method, comprising:
receiving an initial version of a data packet for transmission over a communications network, wherein the communications network comprises a routing core and a plurality of private networks, each private network comprising one or more branches communicably coupled to the routing core;
identifying (i) a destination address from the initial version of the data packet and (ii) a private network identifier of a first private network of the plurality of private networks that corresponds to the data packet, wherein the destination address is encoded in the initial version of the data packet according to a base address plan of the first private network;
converting the initial version of the data packet into a modified version of the data packet by re-encoding the destination address from the base address plan of the first private network to a hyper-address plan of the routing core, the re-encoded destination address in the modified version of the data packet further specifying the private network identifier of the first private network; and
transmitting the modified version of the data packet over the communications network.

2. The computer-implemented method of claim 1, wherein:
the initial version of the data packet is an IPv4 data packet in which the destination address is encoded within a 4-byte wide address field according to the base address plan of the first private network;
the modified version of the data packet is an IPv6 data packet in which the destination address is encoded within a 16-byte wide address field according to the hyper-address plan of the routing core; and
converting the initial version of the data packet into the modified version of the data packet comprises mapping the IPv4 destination address to the IPv6 destination address.

3. The computer-implemented method of claim 2, comprising encoding the IPv4 destination address from the initial version of the data packet in the address field of the IPv6 data packet.

4. The computer-implemented method of claim 3, comprising encoding the private network identifier of the first private network as a prefix in the address field of the IPv6 data packet, the private network identifier of the first private network arranged in the address field of the IPv6 data packet ahead of the IPv4 destination address.

5. The computer-implemented method of claim 1, wherein the communications network comprises a packet-switched network or a circuit-switched network.

6. The computer-implemented method of claim 1, wherein at least one of the plurality of private networks is a virtual private network (VPN).

7. The computer-implemented method of claim 1, wherein:
the initial version of the data packet originates from a host in a first branch of the first private network,
transmitting the modified version of the data packet over the communications network comprises transmitting the modified version of the data packet from a first relay in the routing core that communicates with the first branch of the first private network to a second relay in the routing core that communicates with a second branch of the first private network, and
the second relay forwards the modified version of the data packet for receipt by a gateway in the second branch of the first private network, or the second relay converts the modified version of the data packet to a third version of the data packet that complies with the base address plan of the first private network and forwards the third version of the data packet for receipt by the gateway in the second branch of the first private network.

8. The computer-implemented method of claim 7, wherein the first and second branches of the first private network are geographically separated, and the first and second relays are different from each other.

9. The computer-implemented method of claim 7, wherein the second relay forwards the modified version of the data packet for receipt by the gateway in the second branch of the first private network, and the gateway in the second branch of the first private network converts the modified version of the data packet to a third version of the data packet that complies with the base address plan of the first private network.

10. The computer-implemented method of claim 7, wherein the initial version of the data packet and the third version of the data packet are identical.

11. The computer-implemented method of claim 7, wherein the second relay converts the modified version of the data packet to a third version of the data packet that complies with the base address plan of the first private network and forwards the third version of the data packet for receipt by the gateway in the second branch of the first private network.

12. One or more non-transitory computer-readable media having instructions stored thereon that, when executed by the one or more data processing apparatuses, cause the one or more data processing apparatuses to perform operations comprising:
receiving an initial version of a data packet for transmission over a communications network, wherein the communications network comprises a routing core and a plurality of private networks, each private network comprising one or more branches communicably coupled to the routing core;
identifying (i) a destination address from the initial version of the data packet and (ii) a private network identifier of a first private network of the plurality of private networks that corresponds to the data packet, wherein the destination address is encoded in the initial version of the data packet according to a base address plan of the first private network;
converting the initial version of the data packet into a modified version of the data packet by re-encoding the destination address from the base address plan of the first private network to a hyper-address plan of the routing core, the re-encoded destination address in the modified version of the data packet further specifying the private network identifier of the first private network; and
transmitting the modified version of the data packet over the communications network.

13. The one or more non-transitory computer-readable media of claim 12, wherein:
the initial version of the data packet is an IPv4 data packet in which the destination address is encoded within a 4-byte wide address field according to the base address plan of the first private network;
the modified version of the data packet is an IPv6 data packet in which the destination address is encoded within a 16-byte wide address field according to the hyper-address plan of the routing core; and
converting the initial version of the data packet into the modified version of the data packet comprises mapping the IPv4 destination address to the IPv6 destination address.

14. The one or more non-transitory computer-readable media of claim 13, wherein the operations comprise encoding the IPv4 destination address from the initial version of the data packet in the address field of the IPv6 data packet.

15. The one or more non-transitory computer-readable media of claim 14, wherein the operations comprise encoding the private network identifier of the first private network as a prefix in the address field of the IPv6 data packet, the private network identifier of the first private network arranged in the address field of the IPv6 data packet ahead of the IPv4 destination address.

16. The one or more non-transitory computer-readable media of claim 12, wherein the communications network comprises a packet-switched network or a circuit-switched network.

17. The one or more non-transitory computer-readable media of claim 12, wherein at least one of the plurality of private networks is a virtual private network (VP N).

18. The one or more non-transitory computer-readable media of claim 12, wherein:
the initial version of the data packet originates from a host in a first branch of the first private network,
transmitting the modified version of the data packet over the communications network comprises transmitting the modified version of the data packet from a first relay in the routing core that communicates with the first branch of the first private network to a second relay in the routing core that communicates with a second branch of the first private network, and
the second relay forwards the modified version of the data packet for receipt by a gateway in the second branch of the first private network, or the second relay converts the modified version of the data packet to a third version of the data packet that complies with the base address plan of the first private network and forwards the third version of the data packet for receipt by the gateway in the second branch of the first private network.

19. A computer-implemented method, comprising:
receiving, at a client proxy system and from a client device, a primary request for an electronic resource that is stored on an origin server system;
transmitting, from the client proxy system and to a push server system, the primary request for the electronic resource;
receiving, at the client proxy system and from the push server system, (i) a first response to the primary request for the electronic resource and (ii) a second response to a first secondary request that the push server system independently generated;
caching the second response at the client proxy system;
providing, by the client proxy system, the first response to the client device;
receiving, by the client proxy system, a second secondary request from the client device;
determining, by the client proxy system, whether the second secondary request from the client device corresponds to the cached second response; and
in response to determining that the second secondary request corresponds to the cached second response, providing the cached second response from the client proxy system to the client device,
wherein the client proxy system is a relay in a shared core of a communications network,
wherein the push server system comprises a server external to the shared core of the communications network.

20. The computer-implemented method of claim 19, further comprising inserting dummy packets into communications between the client device and the client proxy system to mask sizes of the communications.
